(19) United States
(12) Patent Application Publication
(10) Pub. No.: US 2025/0063439 A1
(43) Pub. Date: Feb. 20, 2025

(54) INTER-FREQUENCY MEASUREMENT TECHNIQUES

(71) Applicant: QUALCOMM Incorporated, San Diego, CA (US)

(72) Inventors: Haojun WANG, Xian (CN); Kaikai YANG, Xian (CN); Jinglin ZHANG, Shenzhen (CN); Zhenqing CUI, Shanghai (CN); Hong WEI, Shanghai (CN); Tom CHIN, San Diego, CA (US)

(21) Appl. No.: 18/719,694

(22) PCT Filed: Mar. 2, 2022
(86) PCT No.: PCT/CN2022/078731

§ 371 Date: Jun. 13, 2024

(51) Int. Cl. H04W 36/00

(52) U.S. Cl. CPC H04W 36/0058; H04W 36/0085; H04W 36/0094

(57) ABSTRACT

Methods, systems, and devices for wireless communications are described. Some wireless communications systems may support inter-frequency measurement techniques. A user equipment (UE) may receive a control message indicating respective measurement configurations for multiple measurement objects. The UE may perform a measurement of a first measurement object from the plurality of measurement objects and transmit a first measurement report for the first measurement object in accordance with a measurement order. In other examples, the UE may perform measurements of each of the multiple measurement objects, including the first measurement object, prior to transmitting the measurement report, where respective measurement reports may be transmitted in accordance with the measurement order. In any case, the measurement order may be determined using a set of parameters corresponding to a current state of the UE, one or more services at the UE, a user preference, or any combination thereof.

### CROSS REFERENCE

The present Application is a 371 national phase filing of International PCT Application No. PCT/CN2022/078731 by WANG et al., entitled “INTER-FREQUENCY MEASUREMENT TECHNIQUES,” filed Mar. 2, 2022, which is assigned to the assignee hereof, and which is expressly incorporated by reference in its entirety herein.

### FIELD OF TECHNOLOGY

The following relates to wireless communications, including inter-frequency measurement techniques.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communication systems, a UE may be configured to perform measurements that enable the UE to connect to a cell that provides the best communication link. For example, measurement reports sent by the UE may enable a network to determine whether to modify a cell with which the UE is connected, for example, via a handover procedure. Handing over the UE to another cell, however, may not take into account other aspects of the UE's operation, such as a current state of the UE, one or more services running at the UE, user preferences for a type of cell to which the UE is connected, or any combination thereof. Thus, the UE may be handed over to a cell that provides less desirable performance or results in inefficiencies.

### SUMMARY

The described techniques relate to improved methods, systems, devices, and apparatuses that support inter-frequency measurement techniques. Generally, the described techniques provide for determining a measurement order for a set of measurement objects based on a current user equipment (UE) state, services, and/or user preferences. For example, a UE may receive, from a first network entity, a first control message indicating respective measurement configurations for a set of measurement objects. The UE may perform a measurement of a first measurement object from the set of measurement objects according to a measurement order. In some cases, the UE may determine the measurement order based on a set of metrics associated with the set of measurement objects. That is, the UE may generate a metric for each measurement object based on a set of parameters corresponding to a current state of the UE, one or more services at the UE, a user preference, or any combination thereof, and may sort the set of measurement objects according to the generated metrics. For example, the UE may sort the measurement objects in descending order according to the generated metrics. In some cases, the UE may transmit an indication of the determined measurement order to the first network entity.

The UE may transmit a first measurement report for the first measurement object based on one or more reporting conditions being satisfied and, in some cases, initiate a timer based on transmitting the first measurement report. The UE may monitor for a second control message (e.g., a radio resource control (RRC) reconfiguration message). For example, the UE may monitor for an indication from the first network entity to perform a handover procedure to a second network entity associated with the first measurement object. In some cases, the UE may receive the second control message, stop the timer, and perform the handover procedure. Alternatively, the UE may not receive the second control message prior to the expiration of the timer, and the UE may perform a second measurement of a second measurement object from the set of measurement objects in accordance with the measurement order. The UE may transmit the second measurement report based on one or more reporting conditions and, in some cases, iteratively perform the aforementioned process until the UE receives a control message (e.g., for performing a handover procedure).

Additionally, or alternatively, the UE may perform measurements of each measurement object (e.g., prior to transmitting a measurement report). In such cases, the UE may transmit a first measurement report associated with the first measurement in accordance with the measurement order and start a first timer. The UE may monitor for a second control message indicating a configuration associated with the first measurement object and, in some cases, may stop the first timer and perform a handover procedure based on receiving the second control message. If the second control message is not received prior to the expiration of the timer, the UE may transmit a second measurement report for a second measurement object from the set of measurement objects based on the one or more reporting conditions. In some cases, the UE may iteratively perform the aforementioned process until the UE performs a handover procedure based on a received control message.

A method for wireless communications at a UE is described. The method may include receiving a first control message indicating respective measurement configurations for a set of multiple measurement objects, performing a measurement of a first measurement object from the set of multiple measurement objects in accordance with a measurement order, where the measurement order is determined using a set of parameters corresponding to a current state of the UE, one or more services at the UE, a user preference, or any combination thereof, and transmitting a first measurement report for the first measurement object based at least part on one or more reporting conditions being satisfied, the first measurement report being transmitted in accordance with the measurement order.

An apparatus for wireless communications at a UE is described. The apparatus may include a processor, memory coupled with the processor, and instructions stored in the memory. The instructions may be executable by the processor to cause the apparatus to receive a first control message indicating respective measurement configurations for a set of multiple measurement objects, perform a measurement of a first measurement object from the set of multiple measurement objects in accordance with a measurement order, where the measurement order is determined using a set of parameters corresponding to a current state of the UE, one or more services at the UE, a user preference, or any combination thereof, and transmit a first measurement report for the first measurement object based at least part on one or more reporting conditions being satisfied, the first measurement report being transmitted in accordance with the measurement order.

Another apparatus for wireless communications at a UE is described. The apparatus may include means for receiving a first control message indicating respective measurement configurations for a set of multiple measurement objects, means for performing a measurement of a first measurement object from the set of multiple measurement objects in accordance with a measurement order, where the measurement order is determined using a set of parameters corresponding to a current state of the UE, one or more services at the UE, a user preference, or any combination thereof, and means for transmitting a first measurement report for the first measurement object based at least part on one or more reporting conditions being satisfied, the first measurement report being transmitted in accordance with the measurement order.

A non-transitory computer-readable medium storing code for wireless communications at a UE is described. The code may include instructions executable by a processor to receive a first control message indicating respective measurement configurations for a set of multiple measurement objects, perform a measurement of a first measurement object from the set of multiple measurement objects in accordance with a measurement order, where the measurement order is determined using a set of parameters corresponding to a current state of the UE, one or more services at the UE, a user preference, or any combination thereof, and transmit a first measurement report for the first measurement object based at least part on one or more reporting conditions being satisfied, the first measurement report being transmitted in accordance with the measurement order.

Some examples of the method, apparatuses, and non-transitory computer-readable medium described herein may further include operations, features, means, or instructions for generating a metric for each measurement object of the set of multiple measurement objects based on the set of parameters and sorting the set of multiple measurement objects according to the generated metrics, where the measurement order may be determined based on the sorting.

In some examples of the method, apparatuses, and non-transitory computer-readable medium described herein, the set of parameters includes one or more of a throughput parameter, a latency parameter, a battery status parameter, a voice communications parameter, or a mobility parameter.

In some examples of the method, apparatuses, and non-transitory computer-readable medium described herein, at least one parameter of the set of parameters may be weighted according to the user preference.

Some examples of the method, apparatuses, and non-transitory computer-readable medium described herein may further include operations, features, means, or instructions for transmitting a message including an indication of the determined measurement order.

Some examples of the method, apparatuses, and non-transitory computer-readable medium described herein may further include operations, features, means, or instructions for initiating a first timer based on transmitting the first measurement report and monitoring for a second control message indicating a configuration associated with the first measurement report.

Some examples of the method, apparatuses, and non-transitory computer-readable medium described herein may further include operations, features, means, or instructions for receiving the second control message indicating the configuration associated with the first measurement report, stopping the first timer based on receiving the second control message, and performing a handover procedure based on the second control message indicating the configuration associated with the first measurement report.

Some examples of the method, apparatuses, and non-transitory computer-readable medium described herein may further include operations, features, means, or instructions for determining an absence of the second control message upon an expiration of the first timer, performing a second measurement of a second measurement object from the set of multiple measurement objects in accordance with the measurement order, the second measurement being performed based on the absence of the second control message, and transmitting a second measurement report for the second measurement object from the set of multiple measurement objects based at least part on the one or more reporting conditions, the second measurement report being transmitted in accordance with the measurement order.

Some examples of the method, apparatuses, and non-transitory computer-readable medium described herein may further include operations, features, means, or instructions for initiating a second timer based on transmitting the second measurement report and monitoring for a third control message indicating a configuration associated with the second measurement report.

Some examples of the method, apparatuses, and non-transitory computer-readable medium described herein may further include operations, features, means, or instructions for receiving the third control message indicating the configuration associated with the second measurement object, stopping the second timer based on receiving the third control message, and performing a handover procedure based on the third control message indicating the configuration associated with the second measurement report.

Some examples of the method, apparatuses, and non-transitory computer-readable medium described herein may further include operations, features, means, or instructions for determining an absence of the third control message upon an expiration of the second timer, performing a third measurement of a third measurement object of the set of multiple measurement objects in accordance with the measurement order, the third measurement being performed based on the absence of the third control message, and transmitting a third measurement report for the third measurement object from the set of multiple measurement objects based at least part on the one or more reporting conditions, the third measurement report being transmitted in accordance with the measurement order.

Some examples of the method, apparatuses, and non-transitory computer-readable medium described herein may further include operations, features, means, or instructions for selecting the first measurement object for performing the measurement based on the set of parameters indicating a priority for high data rates, low latency, low mobility, or any combination thereof, where the measurement order may be determined based on the priority.

Some examples of the method, apparatuses, and non-transitory computer-readable medium described herein may further include operations, features, means, or instructions for selecting the first measurement object based on the set of parameters indicating a priority for a low battery mode, voice over new radio communications, high mobility, or any combination thereof, where the measurement order may be determined based on the priority.

Some examples of the method, apparatuses, and non-transitory computer-readable medium described herein may further include operations, features, means, or instructions for selecting the first measurement object based on the set of parameters indicating a priority for voice over new radio communications, low mobility, or both, where the measurement order may be determined based on the priority.

In some examples of the method, apparatuses, and non-transitory computer-readable medium described herein, each measurement object of the set of multiple measurement objects may be associated with a millimeter wave frequency band, a time division duplex frequency band, or a frequency division duplex frequency band.

A method for wireless communications at a UE is described. The method may include receiving a first control message indicating respective measurement configurations for a set of multiple measurement objects, performing measurements of each of the set of multiple measurement objects, and transmitting a first measurement report for a first measurement object based at least part on one or more reporting conditions being satisfied, the first measurement report being transmitted in accordance with a measurement order that is determined using a set of parameters corresponding to a current state of the UE, one or more services at the UE, a user preference, or any combination thereof.

An apparatus for wireless communications at a UE is described. The apparatus may include a processor, memory coupled with the processor, and instructions stored in the memory. The instructions may be executable by the processor to cause the apparatus to receive a first control message indicating respective measurement configurations for a set of multiple measurement objects, perform measurements of each of the set of multiple measurement objects, and transmit a first measurement report for a first measurement object based at least part on one or more reporting conditions being satisfied, the first measurement report being transmitted in accordance with a measurement order that is determined using a set of parameters corresponding to a current state of the UE, one or more services at the UE, a user preference, or any combination thereof.

Another apparatus for wireless communications at a UE is described. The apparatus may include means for receiving a first control message indicating respective measurement configurations for a set of multiple measurement objects, means for performing measurements of each of the set of multiple measurement objects, and means for transmitting a first measurement report for a first measurement object based at least part on one or more reporting conditions being satisfied, the first measurement report being transmitted in accordance with a measurement order that is determined using a set of parameters corresponding to a current state of the UE, one or more services at the UE, a user preference, or any combination thereof.

A non-transitory computer-readable medium storing code for wireless communications at a UE is described. The code may include instructions executable by a processor to receive a first control message indicating respective measurement configurations for a set of multiple measurement objects, perform measurements of each of the set of multiple measurement objects, and transmit a first measurement report for a first measurement object based at least part on one or more reporting conditions being satisfied, the first measurement report being transmitted in accordance with a measurement order that is determined using a set of parameters corresponding to a current state of the UE, one or more services at the UE, a user preference, or any combination thereof.

Some examples of the method, apparatuses, and non-transitory computer-readable medium described herein may further include operations, features, means, or instructions for initiating a first timer based on transmitting the first measurement report and monitoring for a second control message indicating a configuration associated with the first measurement report.

Some examples of the method, apparatuses, and non-transitory computer-readable medium described herein may further include operations, features, means, or instructions for receiving the second control message indicating the configuration associated with the first measurement report, stopping the first timer based on receiving the second control message, and performing a handover procedure based on the second control message indicating the configuration associated with the first measurement report.

Some examples of the method, apparatuses, and non-transitory computer-readable medium described herein may further include operations, features, means, or instructions for determining an absence of the second control message upon an expiration of the first timer, transmitting a second measurement report for a second measurement object from the set of multiple measurement objects based at least part on the one or more reporting conditions, the second measurement report being transmitted in accordance with the measurement order, initiating a second timer based on transmitting the second measurement report, and monitoring for a third control message indicating a configuration associated with the second measurement report.

Some examples of the method, apparatuses, and non-transitory computer-readable medium described herein may further include operations, features, means, or instructions for receiving the third control message indicating the configuration associated with the second measurement object, stopping the second timer based on receiving the third control message, and performing a handover procedure based on the third control message indicating the configuration associated with the second measurement report.

Some examples of the method, apparatuses, and non-transitory computer-readable medium described herein may further include operations, features, means, or instructions for determining an absence of the third control message upon an expiration of the second timer and transmitting a third measurement report for a third measurement object from the set of multiple measurement objects based at least part on the one or more reporting conditions, the third measurement report being transmitted in accordance with the measurement order.

In some examples of the method, apparatuses, and non-transitory computer-readable medium described herein, the respective measurement configurations indicate the set of parameters corresponding to the current state of the UE, the one or more services at the UE, the user preference, or any combination thereof.

In some examples of the method, apparatuses, and non-transitory computer-readable medium described herein, the set of parameters includes one or more of a throughput parameter, a latency parameter, a battery status parameter, a voice communications parameter, or a mobility parameter.

In some examples of the method, apparatuses, and non-transitory computer-readable medium described herein, the respective measurement configurations indicate that at least one parameter of the set of parameters may be weighted according to the user preference.

A method for wireless communications at a network entity is described. The method may include transmitting a control message indicating respective measurement configurations for a set of multiple measurement objects, receiving a message including an indication of a measurement order that is based on a set of parameters corresponding to a current state of a UE, one or more services at the UE, a user preference, or any combination thereof, receiving a first measurement report for a first measurement object from the set of multiple measurement objects based at least part on one or more reporting conditions being satisfied, the first measurement report being received in accordance with the measurement order, and comparing one or more quality metrics associated with the first measurement object to respective thresholds for performing a handover of the UE, where the first measurement report includes an indication of the one or more quality metrics.

An apparatus for wireless communications at a network entity is described. The apparatus may include a processor, memory coupled with the processor, and instructions stored in the memory. The instructions may be executable by the processor to cause the apparatus to transmit a control message indicating respective measurement configurations for a set of multiple measurement objects, receive a message including an indication of a measurement order that is based on a set of parameters corresponding to a current state of a UE, one or more services at the UE, a user preference, or any combination thereof, receive a first measurement report for a first measurement object from the set of multiple measurement objects based at least part on one or more reporting conditions being satisfied, the first measurement report being received in accordance with the measurement order, and compare one or more quality metrics associated with the first measurement object to respective thresholds for performing a handover of the UE, where the first measurement report includes an indication of the one or more quality metrics.

Another apparatus for wireless communications at a network entity is described. The apparatus may include means for transmitting a control message indicating respective measurement configurations for a set of multiple measurement objects, means for receiving a message including an indication of a measurement order that is based on a set of parameters corresponding to a current state of a UE, one or more services at the UE, a user preference, or any combination thereof, means for receiving a first measurement report for a first measurement object from the set of multiple measurement objects based at least part on one or more reporting conditions being satisfied, the first measurement report being received in accordance with the measurement order, and means for comparing one or more quality metrics associated with the first measurement object to respective thresholds for performing a handover of the UE, where the first measurement report includes an indication of the one or more quality metrics.

A non-transitory computer-readable medium storing code for wireless communications at a network entity is described. The code may include instructions executable by a processor to transmit a control message indicating respective measurement configurations for a set of multiple measurement objects, receive a message including an indication of a measurement order that is based on a set of parameters corresponding to a current state of a UE, one or more services at the UE, a user preference, or any combination thereof, receive a first measurement report for a first measurement object from the set of multiple measurement objects based at least part on one or more reporting conditions being satisfied, the first measurement report being received in accordance with the measurement order, and compare one or more quality metrics associated with the first measurement object to respective thresholds for performing a handover of the UE, where the first measurement report includes an indication of the one or more quality metrics.

Some examples of the method, apparatuses, and non-transitory computer-readable medium described herein may further include operations, features, means, or instructions for determining that the one or more quality metrics associated with the first measurement object satisfy the respective thresholds for performing a handover of the UE, transmitting a second control message indicating a configuration associated with the first measurement object, and performing a handover procedure based on the second control message indicating the configuration associated with the first measurement object.

Some examples of the method, apparatuses, and non-transitory computer-readable medium described herein may further include operations, features, means, or instructions for receiving a second measurement report for a second measurement object from the set of multiple measurement objects based at least part on the one or more reporting conditions being satisfied, the second measurement report being transmitted in accordance with the measurement order and comparing one or more quality metrics associated with the second measurement object to the respective thresholds for performing a handover of the UE, where the second measurement report includes an indication of the one or more quality metrics.

Some examples of the method, apparatuses, and non-transitory computer-readable medium described herein may further include operations, features, means, or instructions for determining that the one or more quality metrics associated with the second measurement object satisfy the respective thresholds for performing a handover of the UE, transmitting a third control message indicating a configuration associated with the second measurement object, and performing a handover procedure based on the third control message indicating the configuration associated with the second measurement object.

Some examples of the method, apparatuses, and non-transitory computer-readable medium described herein may further include operations, features, means, or instructions for receiving a third measurement report for a third measurement object from the set of multiple measurement objects based at least part on the one or more reporting conditions being satisfied, the third measurement report being transmitted in accordance with the measurement order.

### BRIEF DESCRIPTION OF THE DRAWINGS

FIG. 1 illustrates an example of a wireless communications system that supports inter-frequency measurement techniques in accordance with one or more aspects of the present disclosure.

FIG. 2 illustrates an example of a wireless communications system that supports inter-frequency measurement techniques in accordance with one or more aspects of the present disclosure.

FIG. 3 illustrates an example of a process flow in a system that supports inter-frequency measurement techniques in accordance with one or more aspects of the present disclosure.

FIG. 4 illustrates an example of a process flow in a system that supports inter-frequency measurement techniques in accordance with one or more aspects of the present disclosure.

FIGS. 5 and 6 show block diagrams of devices that support inter-frequency measurement techniques in accordance with one or more aspects of the present disclosure.

FIG. 7 shows a block diagram of a communications manager that supports inter-frequency measurement techniques in accordance with one or more aspects of the present disclosure.

FIG. 8 shows a diagram of a system including a device that supports inter-frequency measurement techniques in accordance with one or more aspects of the present disclosure.

FIGS. 9 and 10 show block diagrams of devices that support inter-frequency measurement techniques in accordance with one or more aspects of the present disclosure.

FIG. 11 shows a block diagram of a communications manager that supports inter-frequency measurement techniques in accordance with one or more aspects of the present disclosure.

FIG. 12 shows a diagram of a system including a device that supports inter-frequency measurement techniques in accordance with one or more aspects of the present disclosure.

FIGS. 13 through 15 show flowcharts illustrating methods that support inter-frequency measurement techniques in accordance with one or more aspects of the present disclosure.

### DETAILED DESCRIPTION

Some wireless communication systems may support wireless devices capable of operating in multiple types of cells supporting different radio frequency spectrum bands (e.g., millimeter wave (mmW) bands, time-division duplex (TDD) bands, frequency-division duplex (FDD) bands, or the like). In some cases, different coverage areas associated with each of the cells may overlap. For example, the coverage area of a first cell associated with a first set of bands (e.g., mmW bands) may overlap with the coverage area of a second cell associated with a second set of bands (e.g., TDD bands), thus providing a user equipment (UE) with the ability to communicate in the first set of bands or the second set of bands. As such, the UE may be configured, by a network, to perform measurements to enable the UE to connect to a cell, for example, via a handover procedure, that provides the best communication link based on the measurements. Such handover procedures, however, may not take into account other aspects of the UE's operation, such as a current state of the UE (e.g., battery status, mobility status), one or more services running at the UE (e.g., low-latency services or applications, Voice over New Radio (VoNR) communications), user preferences for the type of cell to which the UE is connected, or any combination thereof. That is, the handover may be based on measurement results reported to the network without consideration of other aspects of the UE's operation. Thus, the UE may be handed over to a cell that may provide less than desirable performance or result in various inefficiencies.

Techniques described herein may support inter-frequency measurement, such as measurement reporting based on a current UE state, services, and/or user preferences. More specifically, a UE may determine a priority or order to perform and/or report measurements based on the current state of the UE, one or more services running at the UE, user preferences for the type of network entity to which the UE is connected, or any combination thereof. For example, a UE may receive a configuration of a set of measurement objects that may each be associated with different cell types (e.g., a first measurement object for a mmW cell, a second measurement object for a TDD cell, a third measurement object for an FDD cell, and so forth). The UE may calculate a priority of the measurement objects based on one or more parameters corresponding to the current UE state, one or more supported services, and/or user preferences.

Based on the priority, the UE may sequentially measure and/or report the measurement objects to a network, thereby enabling the UE to connect (e.g., via handover) to a cell that provides desired communications. For example, the UE may perform a first measurement of a first measurement object and then transmit a measurement report for the first measurement object in accordance with the priority (e.g., before performing a second measurement of a second, different measurement object). In other examples, the UE may measure each of the measurement objects and then transmit the measurement reports for the respective measurement objects in accordance with the priority (e.g., transmit a first measurement report for a first measurement object before a second measurement report for a second measurement object).

In some aspects, the UE may begin a timer (e.g., a guard timer) after transmitting a first measurement report for a first measurement object and may receive a response from the network before the timer expires, the response configuring the UE to connect, such as via a handover procedure, to a cell associated with the first measurement object. In some other aspects, the UE may begin the timer after transmitting the first measurement report and, if no response is received from the network before the timer expires, the UE may transmit a second measurement report for another measurement object.

Aspects of the disclosure are initially described in the context of wireless communications systems. Aspects of the disclosure are then described in the process flows. Aspects of the disclosure are further illustrated by and described with reference to apparatus diagrams, system diagrams, and flowcharts that relate to inter-frequency measurement techniques.

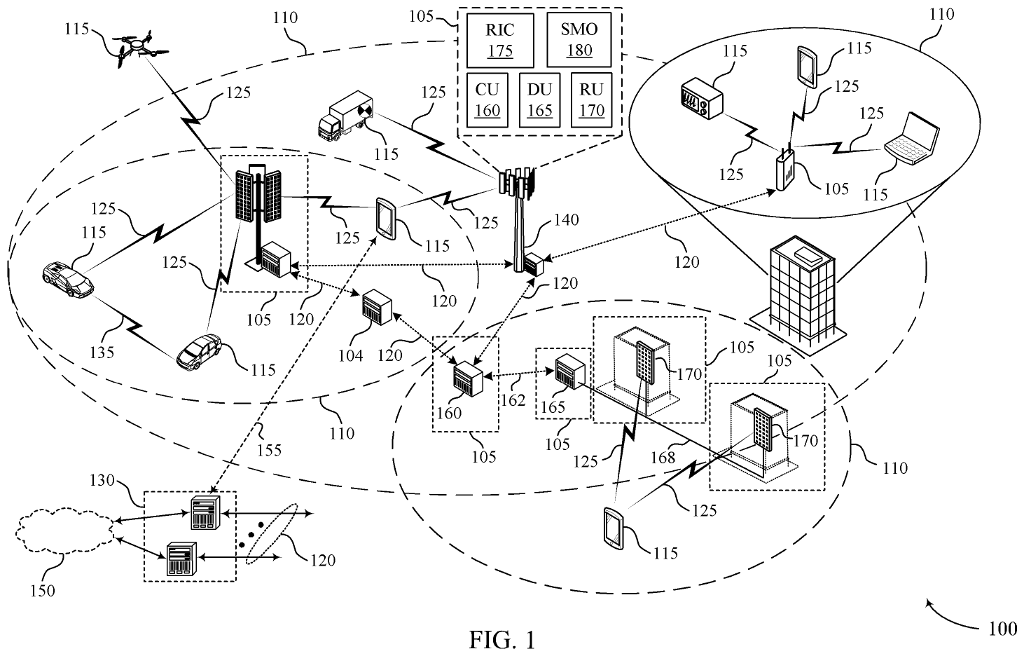

FIG. 1 illustrates an example of a wireless communications system 100 that supports inter-frequency measurement techniques in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104. In the case of the techniques described herein applied in the context of a disaggregated RAN architecture, one or more components of the disaggregated RAN architecture may be configured to support inter-frequency measurement techniques as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing and time division duplexing component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support mmW communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may support inter-frequency measurement techniques for determining a measurement order based on a current UE state, services, and/or user preferences. For example, a UE 115 may receive a control message indicating respective measurement configurations for a set of measurement objects. In some cases, the UE 115 may generate a metric for each measurement object based on a set of parameters corresponding to a current state of the UE 115, one or more services at the UE 115, a user preference, or any combination thereof. For example, the set of parameters may include one or more of a throughput parameter, a latency parameter, a battery status parameter, a voice communications parameter, or a mobility parameter. The UE 115 may sort the measurement objects according to the generated metrics (e.g., in descending order) to determine a measurement order. In some cases, the UE 115 may transmit an indication of the determined measurement order to a network entity 105.

In some cases, the UE 115 may perform a measurement of a first measurement object of the set of measurement objects in accordance with the measurement order. For example, the UE 115 may select the first measurement object based on the metric associated with the first measurement object being greater than metrics associated with other measurement objects, such as a second measurement object and a third measurement object. In some other cases, the UE 115 may perform measurements of each of the set of measurement objects. That is, the UE 115 may perform a measurement of the first measurement object, the second measurement object, the third measurement object, and so on. Additionally, the UE 115 may transmit a first measurement report for the first measurement in accordance with the measurement order. Further, the UE 115 may transmit the first measurement report based on one or more reporting conditions being satisfied.

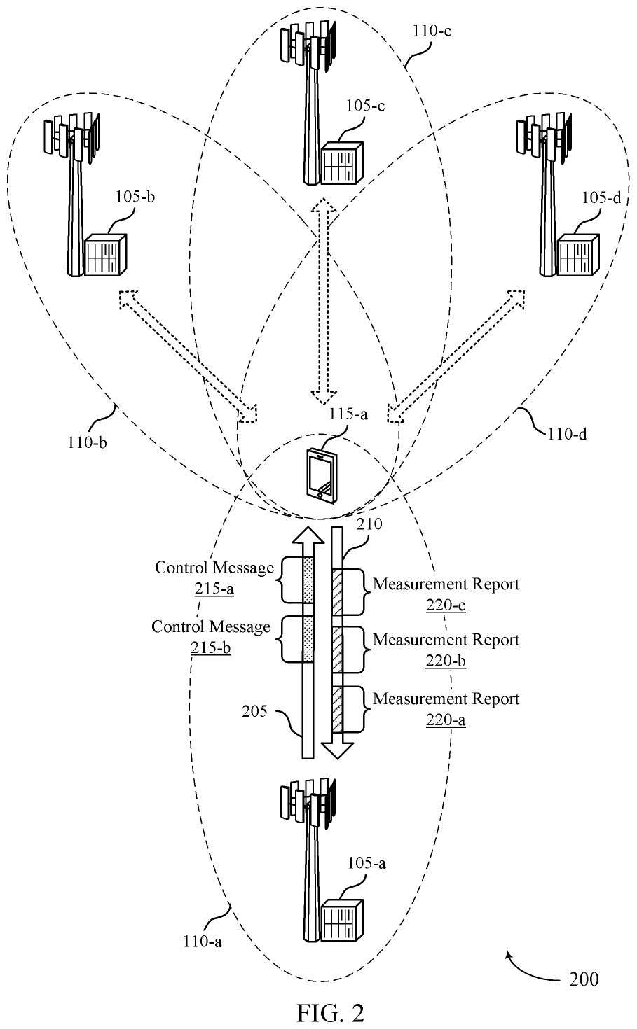

FIG. 2 illustrates an example of a wireless communications system 200 that supports inter-frequency measurement techniques in accordance with one or more aspects of the present disclosure. For example, the wireless communications system 200 may include a network entity 105-a, a network entity 105-b, a network entity 105-c, a network entity 105-d, and a UE 115-a. The network entity 105-a, the network entity 105-b, the network entity 105-c, and the network entity 105-d may represent examples of network entities 105 as described herein, including with reference to FIG. 1. The UE 115-a may represent an example of a UE 115 as described herein, including with reference to FIG. 1.

The wireless communications system 200 may support communications between the UE 115-a and the network entities 105. For example, the UE 115-a may receive downlink messages over a communication link 205 (which may be an example of a communication link 125) and may transmit uplink messages over a communication link 210 (which may be an example of a communication link 125) while operating in a coverage area 110-a. For example, the network entity 105-a may transmit, to the UE 115-a, a control message 215-a indicating respective measurement configurations for a set of measurement objects. In some aspects, each network entity 105 may be associated with or provide a respective cell. For instance, the network entity 105-b may be associated with a first cell, the network entity 105-c may be associated with a second cell different from the first cell, and the network entity 105-d may be associated with a third, different cell. Each cell may be support wireless communications with various radio frequency spectrum bands.

The wireless communication system 200 may support wireless devices capable of operating in multiple types of radio frequency spectrum bands (e.g., mmW, TDD, and FDD bands). In some cases, different coverage areas associated with each of the radio frequency bands may overlap. For example, a network entity 105-b may support a first set of bands (e.g., mmW bands) in a coverage area 110-b, a network entity 105-c may support a second set of bands (e.g., TDD bands) in a coverage area 110-c, and a network entity 105-d may support a third set of bands (e.g., FDD band) in a coverage area 110-d. The coverage areas 110 may overlap, and the UE 115-a, operating in the overlapping coverage area 110, may have the ability to communicate with the network entity 105-b in the first set of bands, with the network entity 105-c in the second set of bands, or with the network entity 105-d in the third set of bands.

The UE 115-a may be configured, by the network entity 105-a, to perform measurements to enable the UE 115-a to connect to another network entity 105 (such as the network entity 105-b, the network entity 105-c, or the network entity 105-d), for example, via a handover procedure, that provides the best communication link based on the measurements. The handover procedure, however, may not take into account other aspects of the UE's 115 operation, such as a current state of the UE 115 (e.g., battery status, mobility status), one or more services running at the UE 115 (e.g., low-latency services or applications, VoNR communications), user preferences for the type of network entity 105 (e.g., cell) to which the UE 115 is connected, or any combination thereof. Thus, the UE 115 may be handed over to a network entity 105 that may provide less than desirable performance or result in various inefficiencies. For example, the first set of bands associated with the network entity 105-b may support a relatively higher data rate while the second set of bands associated with the 105-c may support relatively lower power consumption. Thus, in cases where the UE 115-a is operating in a low power mode, the network entity 105-a may attempt to hand over the UE 115-a to the network entity 105-b, resulting in less than desirable performance of the UE 115-a and potentially affecting power management at the UE 115-a.

As described herein, the wireless communications system 200 may support inter-frequency measurement techniques to enable the UE 115-a to transmit measurement reports 220 to the network entity 105-a in accordance with a measurement order based on a current state of the UE 115-a, services, and/or user preferences. For example, the UE 115-a may receive a control message 215-a (e.g., RRCReconfiguration) from the network entity 105-a indicating respective measurement configurations for a set of measurement objects (e.g., based on the UE 115-a reporting degradation of communication with the network entity 105-a). In some cases, the respective measurement configurations may include an indication of reporting conditions for each measurement object. Further, each measurement object may be associated with a different set of bands (e.g., mmW, TDD, FDD) and, as such, a different network entity 105 (e.g., cell). For instance, respective measurement objects may be associated with different frequency categories, such as a first measurement object being associated with mmW radio frequency spectrum bands, a second measurement object being associated with TDD radio frequency spectrum bands, and so on.

In some cases, the UE 115-a may generate a metric (e.g., priority) for each measurement object based on a set of parameters corresponding to a current state of the UE 115-a, one or more services at the UE 115-a, a user preference, or any combination thereof. For example, the set of parameters may include one or more of a throughput parameter (e.g., m_High_throughput), a latency parameter (e.g., m_Low_latency), a battery status parameter (e.g., m_Low_power), a voice communications parameter (e.g., m_VoNR), or a mobility parameter (e.g., m_Low_mobility or m_High_mobility). As an illustrative example, each parameter may have a value range (e.g., 0 to 3) and the UE 115-a may select a value in each range based on the current state of the UE 115-a, the services at the UE 115-a, the user preference, or any combination thereof (e.g., m_High_throughput equal to 3 indicates a high throughput scenario). In some cases, at least one parameter may be weighted according to user preference. For example, the UE 115-a may be transmitting high priority data and, as such, may increase the weighting of the latency parameter. The UE 115-a may generate each quality metric by adding the values of a subset of the parameters, wherein the subset is based on the measurement object.

The UE 115-a may sort the measurement objects according to the generated metrics (e.g., Sort (mmW_Meas, FDD_Meas, TDD_Meas)). For example, the UE 115-a may sort the generated metrics in descending order to determine a measurement order (e.g., largest metric first, smallest metric last). In examples where two or more generated metrics may be equal in value, the UE 115-a may determine the order of the measurement objects associated with the equal metrics based on user preference. For example, a first metric associated with a first measurement object may be equal to a second metric associated with a second measurement object.

In some examples, the UE 115-a may prioritize the first measurement object based on the set of parameters indicating a priority for high data rates, low latency, low mobility, or any combination thereof (e.g., the UE 115-a may prioritize a measurement object for a mmW cell). In some other examples, the UE 115-a may prioritize the first measurement object based on the set of parameters indicating a priority for a low battery mode, some communications type (e.g., VoNR communications), relatively high mobility, or any combination thereof (e.g., the UE 115-a may prioritize a measurement object for an FDD cell). In some other examples, the UE 115-a may prioritize the first measurement object based on the set of parameters indicating a priority for some communication types (e.g., VoNR communications), relatively low mobility, or both (e.g., the UE 115-a may prioritize a measurement object for a TDD cell). In some cases, the UE 115-a may transmit an indication of the determined measurement order to the network entity 105-a. For instance, the UE 115-a may transmit a message including an indication of the determined order or priority of configured measurement objects, where the order or priority is based on a current state of the UE 115-a, services at the UE 115-a, and/or user preferences.

In some cases, the UE 115-a may perform a measurement of the first measurement object in accordance with the measurement order and may transmit a measurement report 220-a (e.g., MeasurementReport) associated with the first measurement object to the network entity 105-a based on one or more reporting conditions being satisfied. The UE 115-a may initiate a first timer (e.g., a guard timer) based on transmitting the measurement report 220-a and may monitor for a control message 215-b (e.g., RRCReconfiguration) indicating a configuration associated with the first measurement object. The guard timer may be, for example, 50 ms in duration, 200 ms in duration, or some other time duration.

Upon receiving the measurement report 220-a, the network entity 105-a may compare one or more quality metrics associated with the first measurement object to respective thresholds for performing a handover procedure. That is, the measurement report 220-a may contain one or more quality metrics (e.g., for a measured beam) associated with the first measurement object. The network entity 105-a may compare the one or more quality metrics to respective thresholds to determine if a communication link associated with the first measurement object provides sufficient communication performance for the UE 115-a.

In some cases, the network entity 105-a may transit the control message 215-b indicating the configuration associated with the first measurement object based on the one or more quality metrics satisfying the respective thresholds. The UE 115-a may receive the control message 215-b and stop the first timer based on receiving the control message 215-b. Further, the UE 115-a may perform a handover procedure based on the control message 215-b indicating the configuration associated with the first measurement object. Upon performing the handover (e.g., to a target cell), the UE 115-a may transmit an indication (e.g., RRCConfiguration_Complete) to confirm a completion of a connection with the target cell (e.g., indicating that an RRC connection has been established). Thus, the network entity 105-a may hand over the UE 115-a to a network entity 105 providing a cell that is associated with the first measurement object.

In some other cases, the UE 115-a may not receive the control message 215-b. For instance, after monitoring for the control message for the duration of the timer, the UE 115-a may determine an absence of the control message 215-b upon expiration of the first timer. As a result, the UE 115-a may perform a second measurement of a second measurement object from the set of measurement objects in accordance with the measurement order. The UE 115-a may transmit a measurement report 220-b associated with the second measurement object to the network entity 105-a when one or more reporting conditions are satisfied. The UE 115-a may initiate a second timer (e.g., a guard timer) based on transmitting the measurement report 220-b and may monitor for a control message 215-b indicating a configuration associated with the second measurement object.

The network entity 105-a may, based on the measurement report 220-b, compare one or more quality metrics associated with the second measurement object to respective thresholds for performing a handover procedure. That is, the measurement report 220-b may contain one or more quality metrics (e.g., for a measured beam) associated with the second measurement object. The network entity 105-a may compare the one or more quality metrics to respective thresholds to determine if a communication link associated with the second measurement object provides sufficient communication performance.

The network entity 105-a may determine to hand over the UE 115-a to another cell based on the measurement report 220-b for the second measurement object. In such cases, the network entity 105-a may transit the control message 215-b indicating the configuration associated with the second measurement object based on the one or more quality metrics satisfying the respective thresholds. The UE 115-a may receive the control message 215-b and stop the second timer based on receiving the control message 215-b. Further, the UE 115-a may perform a handover procedure based on the control message 215-b indicating the configuration associated with the second measurement object. That is, the network entity 105-a may hand over the UE 115-a to a network entity 105 providing a cell that is associated with the second measurement object.

Alternatively, the UE 115-a may not receive the control message 215-b and determine an absence of the control message 215-b. The determination that the second control message 215-b has not been received may be made upon the expiration of the second timer. The UE 115-a may then perform a third measurement of a third measurement object in accordance with the measurement order. The UE 115-a may transmit a measurement report 220-c associated with the third measurement object to the network entity 105-a based on one or more reporting conditions being satisfied. The UE 115-a may initiate a third timer (e.g., guard timer) based on transmitting the measurement report 220-c and may monitor for a control message 215-b indicating a configuration associated with the third measurement object.

Based on a comparison of one or more quality metrics associated with the third measurement object to respective thresholds for performing a handover procedure, the network entity 105-a may determine to modify a cell of the UE 115-a. For example, the measurement report 220-c may contain one or more quality metrics (e.g., for a measured beam) associated with the third measurement object. As such, the network entity 105-a may compare the one or more quality metrics to respective thresholds to determine if a communication link associated with the third measurement object provides sufficient communication performance.

In some cases, the network entity 105-a may transit the control message 215-b indicating the configuration associated with the third measurement object based on the one or more quality metrics satisfying the respective thresholds. The UE 115-a may receive the control message 215-b and stop the third timer based on receiving the control message 215-b. Further, the UE 115-a may perform a handover procedure based on the control message 215-b indicating the configuration associated with the third measurement object. That is, the network entity 105-a may hand over the UE 115-a to a network entity 105 providing a cell that is associated with the third measurement object. In some other cases, the control message 215-b may not be received by the UE 115-a when the third timer expires, and the UE 115-a may continue to iteratively perform the techniques described previously with additional measurement objects (e.g., a fourth measurement object, a fifth measurement object, and so on).

Additionally, or alternatively, the UE 115-a may perform measurements of each measurement object (e.g., prior to transmitting a measurement report 220). In such cases, the UE 115-a may transmit the measurement report 220-a based on the one or more reporting conditions being satisfied and start the first timer. In such cases, the measurement report 220-a may be sent based on the determined measurement order. The UE 115-a may monitor for the control message 215-b indicating the configuration associated with the first measurement object and, in some cases, may stop the first timer and perform a handover procedure based on receiving the control message 215-b. In cases where the control message 215-b is not received prior to the expiration of the first timer, the UE 115-a may transmit the measurement report 220-b for the second measurement object based on the one or more reporting conditions being satisfied and in accordance with the measurement order. The UE 115-a may iteratively perform the aforementioned process after transmission of the measurement report 220-b and subsequent measurement reports 220 for additional measurement objects (e.g., the third measurement object, a fourth measurement object, and so on).

Performing the inter-frequency measurement techniques described herein may enable the UE 115-a to transmit measurement reports 220 to the network entity 105-a in accordance with a measurement order (e.g., a priority) based on a current state of the UE 115-a, services, and/or user preferences. Such techniques may result in improved performance of the UE 115-a, improved user experience, reduced power consumption, high data performance in data transferring scenarios, decreased handover procedures in high mobility scenarios, and increased performance in low mobility scenarios, among other advantages.

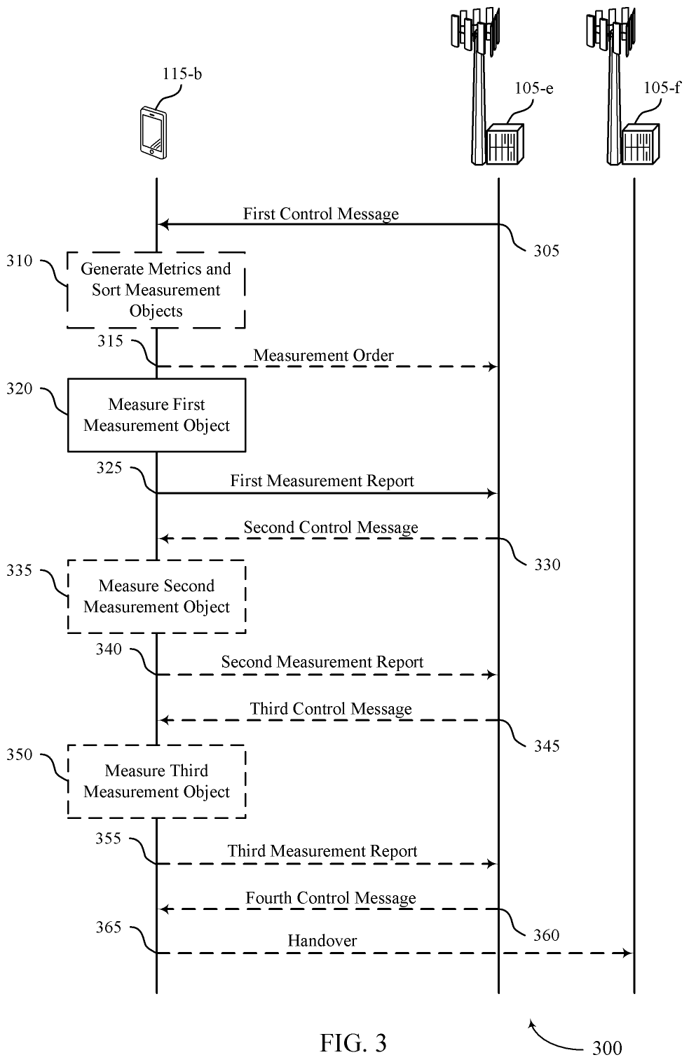

FIG. 3 illustrates an example of a process flow 300 in a system that supports inter-frequency measurement techniques in accordance with one or more aspects of the present disclosure. The process flow 300 may implement or be implemented by aspects of the wireless communications system 100 and wireless communications system 200. For example, the process flow 300 may include a network entity 105-e, a network entity 105-f, and UE 115-b. The network entity 105-e and the network entity 105-f may represent examples of network entities 105 as described herein, including with reference to FIG. 1. The UE 115-b may represent example of a UE 115 as described herein, including with reference to FIG. 1. For example, the UE 115-b may receive a control message from the network entity 105-e indicating respective measurement configurations for a set of measurement objects.

At 305, the UE 115-b may receive, from the network entity 105-e, a first control message indicating respective measurement configurations for a set of measurement objects. In some cases, each of the measurement objects may be associated with a mmW frequency band, a TDD frequency band, or a FDD frequency band.

At 310, the UE 115-b may generate a metric for each measurement object of the set of measurement objects based on a set of parameters corresponding to a current state of the UE 115-b, one or more services at the UE 115-b, a user preference, or any combination thereof. In some cases, the set of parameters may include one or more of a throughput parameter, a latency parameter, a battery status parameter, a voice communications parameter, or a mobility parameter. Additionally, or alternatively, at least one of the parameters may be weighted according to user preference. For example, the UE 115-b may operate in a high mobility scenario and may weight the mobility parameter accordingly.

In some cases, the UE 115-b may sort the set of measurement objects, for example, in descending order, according to the generated metrics to determine a measurement order. For example, the UE 115-b may determine a first metric for a first measurement object, a second metric for a second measurement object, a third metric for a third measurement object, and so on.

At 315, the UE 115-b may transmit an indication of the determined measurement order to the network entity 105-e.

At 320, the UE 115-b may perform a measurement of a first measurement object from the set of measurement objects in accordance with the measurement order. In some cases, the UE 115-b may select the first measurement object based on the set of parameters indicating a priority for high data rates, low latency, low mobility, or any combination thereof. In some other cases, the UE 115-b may select the first measurement object based on the set of parameters indicating a priority for a low battery mode, VoNR communications, high mobility, or any combination thereof. In some examples, the UE 115-b may select the first measurement object based on the set of parameters indicating a priority for VoNR communications, low mobility, or both.

At 325, the UE 115-b may transmit a first measurement report for the first measurement object in accordance with the measurement order and based on one or more reporting conditions. In some cases, the UE 115-b may initiate a first timer, such as a guard timer, based on transmitting the first measurement report and may monitor (e.g., during the duration of the first timer) for a second control message indicating a configuration associated with the first measurement report. For example, the configuration may include parameters associated with a handover procedure, such as identifying information for a network entity 105-f associated with the first measurement object. In some cases, the network entity 105-e may compare one or more quality metrics associated with the first measurement object to respective thresholds for performing a handover of the UE 115-b.

At 330, the network entity 105-e may transmit the second control message based on the one or more quality metrics associated with the first measurement object exceeding the respective thresholds. The UE 115-b may receive the second control message and stop the first timer based on receiving the second control message.

In some cases, the UE 115-b may determine an absence of the second control message prior to expiration of the first timer and, at 335, may perform a measurement of a second measurement object from the set of measurement objects in accordance with the measurement order.

At 340, the UE 115-b may transmit a second measurement report for the second measurement object in accordance with the measurement order and based on the one or more reporting conditions. In some cases, the UE 115-b may initiate a second timer, such as a guard timer, based on transmitting the second measurement report and may monitor (e.g., during the duration of the second timer) for a third control message indicating a configuration associated with the second measurement report. For example, the configuration may include parameters associated with a handover procedure, such as identifying information for a network entity 105-f associated with the second measurement object. In some cases, the network entity 105-e may compare one or more quality metrics associated with the second measurement object to respective thresholds for performing a handover of the UE 115-b.

At 345, the network entity 105-e may transmit the third control message based on the one or more quality metrics associated with the second measurement object exceeding the respective thresholds. The UE 115-b may receive the third control message and stop the second timer based on receiving the third control message. In some cases, the UE 115-b may determine an absence of the third control message prior to expiration of the second timer and, at 350, may perform a measurement of a third measurement object from the set of measurement objects in accordance with the measurement order.

At 355, the UE 115-b may transmit a third measurement report for the third measurement object in accordance with the measurement order and based on the one or more reporting conditions. In some cases, the UE 115-b may initiate a third timer, such as a guard timer, based on transmitting the third measurement report and may monitor (e.g., during the duration of the third timer) for a fourth control message indicating a configuration associated with the third measurement report. For example, the configuration may include parameters associated with a handover procedure, such as identifying information for a network entity 105-f associated with the third measurement object. In some cases, the network entity 105-e may compare one or more quality metrics associated with the third measurement object to respective thresholds for performing a handover of the UE 115-b.

At 360, the network entity 105-e may transmit the fourth control message based on the one or more quality metrics associated with the third measurement object exceeding the respective thresholds. The UE 115-b may receive the fourth control message and stop the third timer based on receiving the fourth control message.

At 365, the UE 115-b may perform a handover procedure based on the second control message, the third control message, or the fourth control message. That is, the UE 115-b may be handed over to a network entity 105-f providing a cell that is associated with a measurement object corresponding to the respective control message. For example, the UE 115-b may perform a handover procedure based on receiving the third control message and may be handed over to a network entity 105-f associated with the second measurement object.

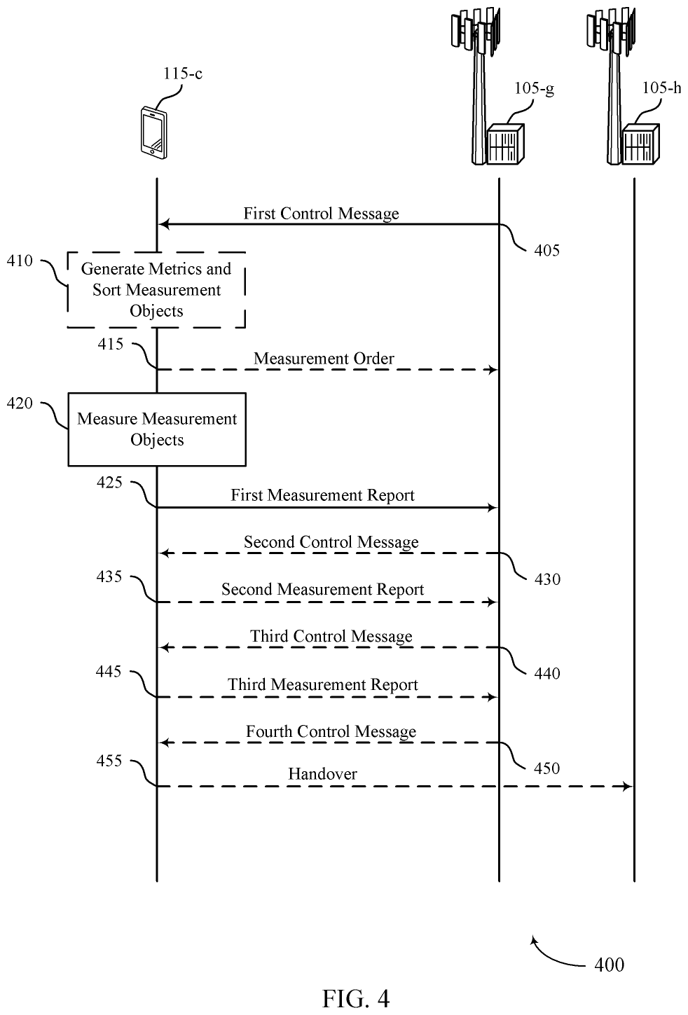

FIG. 4 illustrates an example of a process flow 400 in a system that supports inter-frequency measurement techniques in accordance with one or more aspects of the present disclosure. The process flow 400 may implement or be implemented by aspects of the wireless communications system 100 and wireless communications system 200. For example, the process flow 400 may include a network entity 105-g, a network entity 105-h, and UE 115-c. The network entity 105-g and the network entity 105-h may represent examples of network entities 105 as described herein, including with reference to FIG. 1. The UE 115-c may represent example of a UE 115 as described herein, including with reference to FIG. 1. For example, the UE 115-c may receive a control message from the network entity 105-g indicating respective measurement configurations for a set of measurement objects.

At 405, the UE 115-c may receive, from the network entity 105-g, a first control message indicating respective measurement configurations for a set of measurement objects. In some cases, each of the measurement objects may be associated with a mmW frequency band, a TDD frequency band, or a FDD frequency band.

At 410, the UE 115-c may generate a metric for each measurement object of the set of measurement objects based on a set of parameters corresponding to a current state of the UE 115-c, one or more services at the UE 115-c, a user preference, or any combination thereof. In some cases, the set of parameters may include one or more of a throughput parameter, a latency parameter, a battery status parameter, a voice communications parameter, or a mobility parameter. Additionally, or alternatively, at least one of the parameters may be weighted according to user preference. For example, the UE 115-c may operate in a high mobility scenario and may weight the mobility parameter accordingly.

In some cases, the UE 115-c may sort the set of measurement objects, for example, in descending order, according to the generated metrics to determine a measurement order. For example, the UE 115-c may determine a first metric for a first measurement object, a second metric for a second measurement object, a third metric for a third measurement object, and so on.

At 415, the UE 115-c may transmit an indication of the determined measurement order to the network entity 105-g. At 420, the UE 115-c may perform measurements of each of the measurement objects.

At 425, the UE 115-c may transmit a first measurement report for a first measurement object from the set of measurement objects in accordance with the measurement order and based on one or more reporting conditions. In some cases, the UE 115-c may select the first measurement object based on the set of parameters indicating a priority for high data rates, low latency, low mobility, or any combination thereof. In some other cases, the UE 115-c may select the first measurement object based on the set of parameters indicating a priority for a low battery mode, VoNR communications, high mobility, or any combination thereof. In some other cases, the UE 115-c may select the first measurement object based on the set of parameters indicating a priority for VoNR communications, low mobility, or both. In some cases, the network entity 105-g may compare one or more quality metrics associated with the first measurement object to respective thresholds for performing a handover of the UE 115-c.

In some cases, the UE 115-c may initiate a first timer, such as a guard timer, based on transmitting the first measurement report and may monitor (e.g., during the duration of the first timer) for a second control message indicating a configuration associated with the first measurement report. For example, the configuration may include parameters associated with a handover procedure, such as identifying information for a network entity 105-h associated with the first measurement object.

At 430, the network entity 105-g may transmit the second control message based on the one or more quality metrics associated with the first measurement object exceeding the respective thresholds. The UE 115-c may receive the second control message and stop the first timer based on receiving the second control message.

The UE 115-c may determine an absence of the second control message prior to expiration of the first timer and, at 435, may transmit a second measurement report for a second measurement object from the set of measurement objects in accordance with the measurement order and based on the one or more reporting conditions. In some cases, the UE 115-c may initiate a second timer, such as a guard timer, based on transmitting the second measurement report and may monitor (e.g., during the duration of the second timer) for a third control message indicating a configuration associated with the second measurement report. For example, the configuration may include parameters associated with a handover procedure, such as identifying information for a network entity 105-h associated with the second measurement object. In some cases, the network entity 105-g may compare one or more quality metrics associated with the second measurement object to respective thresholds for performing a handover of the UE 115-c.

At 440, the network entity 105-g may transmit the third control message based on the one or more quality metrics associated with the second measurement object exceeding the respective thresholds. The UE 115-c may receive the third control message and stop the second timer based on receiving the third control message.

The UE 115-c may determine an absence of the third control message prior to expiration of the second timer and, at 445, may transmit a third measurement report for a third measurement object from the set of measurement objects in accordance with the measurement order and based on the one or more reporting conditions. In some cases, the UE 115-c may initiate a third timer, such as a guard timer, based on transmitting the third measurement report and may monitor (e.g., during the duration of the third timer) for a fourth control message indicating a configuration associated with the third measurement report. For example, the configuration may include parameters associated with a handover procedure, such as identifying information for a network entity 105-h associated with the third measurement object. In some cases, the network entity 105-g may compare one or more quality metrics associated with the third measurement object to respective thresholds for performing a handover of the UE 115-c.

At 450, the network entity 105-g may transmit the fourth control message based on the one or more quality metrics associated with the third measurement object exceeding the respective thresholds. The UE 115-c may receive the fourth control message and stop the third timer based on receiving the fourth control message.

At 455, the UE 115-c may perform a handover procedure based on the second control message, the third control message, or the fourth control message. That is, the UE 115-c may be handed over to a network entity 105-h associated with a measurement object corresponding to the respective control message. For example, the UE 115-c may perform a handover procedure based on receiving the third control message and may be handed over to a network entity 105-h associated with the second measurement object.

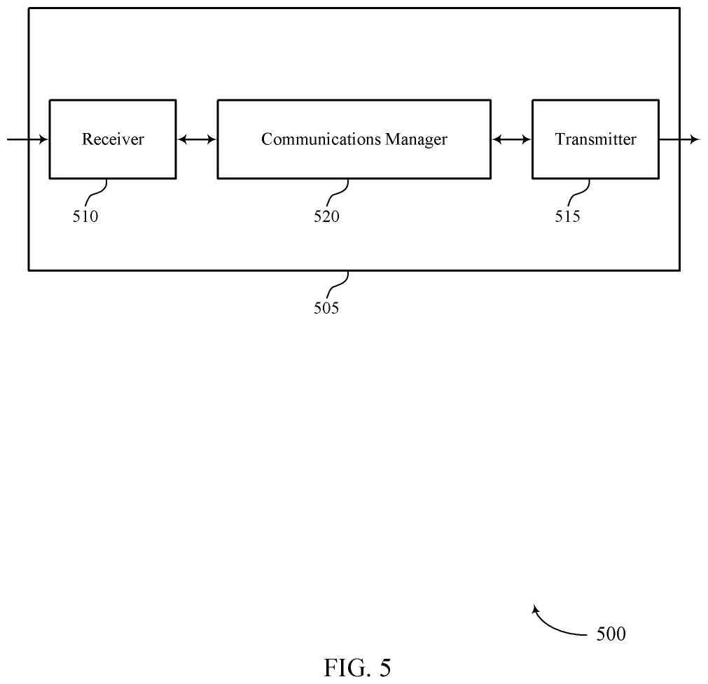

FIG. 5 shows a block diagram 500 of a device 505 that supports inter-frequency measurement techniques in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to inter-frequency measurement techniques). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to inter-frequency measurement techniques). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of inter-frequency measurement techniques as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 may be configured as or otherwise support a means for receiving a first control message indicating respective measurement configurations for a set of multiple measurement objects. The communications manager 520 may be configured as or otherwise support a means for performing a measurement of a first measurement object from the set of multiple measurement objects in accordance with a measurement order, where the measurement order is determined using a set of parameters corresponding to a current state of the UE, one or more services at the UE, a user preference, or any combination thereof. The communications manager 520 may be configured as or otherwise support a means for transmitting a first measurement report for the first measurement object based at least part on one or more reporting conditions being satisfied, the first measurement report being transmitted in accordance with the measurement order.

Additionally, or alternatively, the communications manager 520 may support wireless communications at a UE in accordance with examples as disclosed herein. For example, the communications manager 520 may be configured as or otherwise support a means for receiving a first control message indicating respective measurement configurations for a set of multiple measurement objects. The communications manager 520 may be configured as or otherwise support a means for performing measurements of each of the set of multiple measurement objects. The communications manager 520 may be configured as or otherwise support a means for transmitting a first measurement report for a first measurement object based at least part on one or more reporting conditions being satisfied, the first measurement report being transmitted in accordance with a measurement order that is determined using a set of parameters corresponding to a current state of the UE, one or more services at the UE, a user preference, or any combination thereof.

By including or configuring the communications manager 520 in accordance with examples as described herein, the device 505 (e.g., a processor controlling or otherwise coupled with the receiver 510, the transmitter 515, the communications manager 520, or a combination thereof) may support inter-frequency measurement techniques for determining a measurement order based on a current UE state, services, and/or user preferences which may result in reduced processing, reduced power consumption, and more efficient utilization of communication resources, among other advantages.

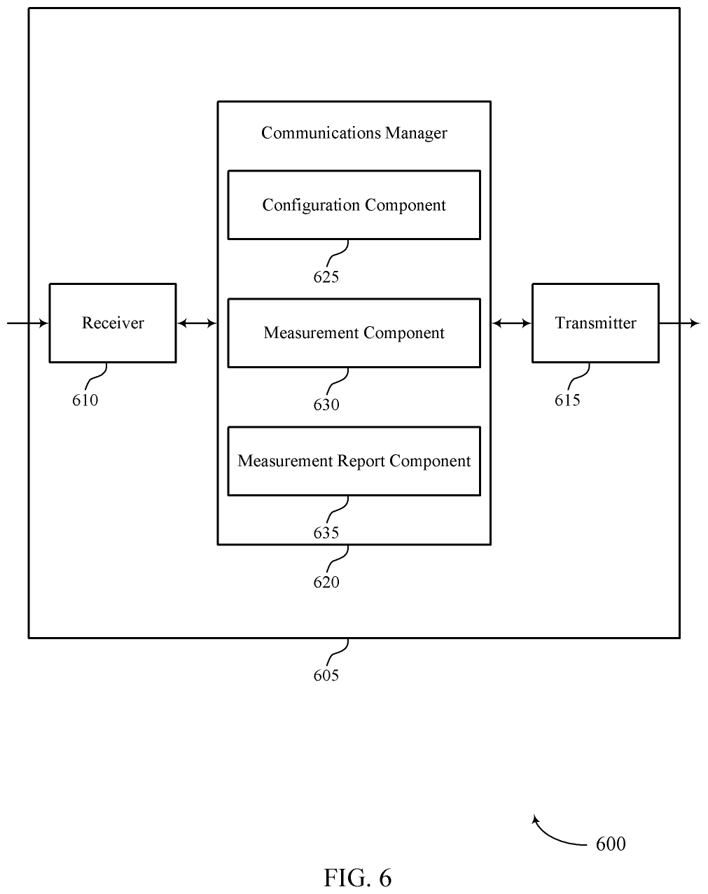

FIG. 6 shows a block diagram 600 of a device 605 that supports inter-frequency measurement techniques in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to inter-frequency measurement techniques). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to inter-frequency measurement techniques). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of inter-frequency measurement techniques as described herein. For example, the communications manager 620 may include a configuration component 625, a measurement component 630, a measurement report component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The configuration component 625 may be configured as or otherwise support a means for receiving a first control message indicating respective measurement configurations for a set of multiple measurement objects. The measurement component 630 may be configured as or otherwise support a means for performing a measurement of a first measurement object from the set of multiple measurement objects in accordance with a measurement order, where the measurement order is determined using a set of parameters corresponding to a current state of the UE, one or more services at the UE, a user preference, or any combination thereof. The measurement report component 635 may be configured as or otherwise support a means for transmitting a first measurement report for the first measurement object based at least part on one or more reporting conditions being satisfied, the first measurement report being transmitted in accordance with the measurement order.

Additionally, or alternatively, the communications manager 620 may support wireless communications at a UE in accordance with examples as disclosed herein. The configuration component 625 may be configured as or otherwise support a means for receiving a first control message indicating respective measurement configurations for a set of multiple measurement objects. The measurement component 630 may be configured as or otherwise support a means for performing measurements of each of the set of multiple measurement objects. The measurement report component 635 may be configured as or otherwise support a means for transmitting a first measurement report for a first measurement object based at least part on one or more reporting conditions being satisfied, the first measurement report being transmitted in accordance with a measurement order that is determined using a set of parameters corresponding to a current state of the UE, one or more services at the UE, a user preference, or any combination thereof.

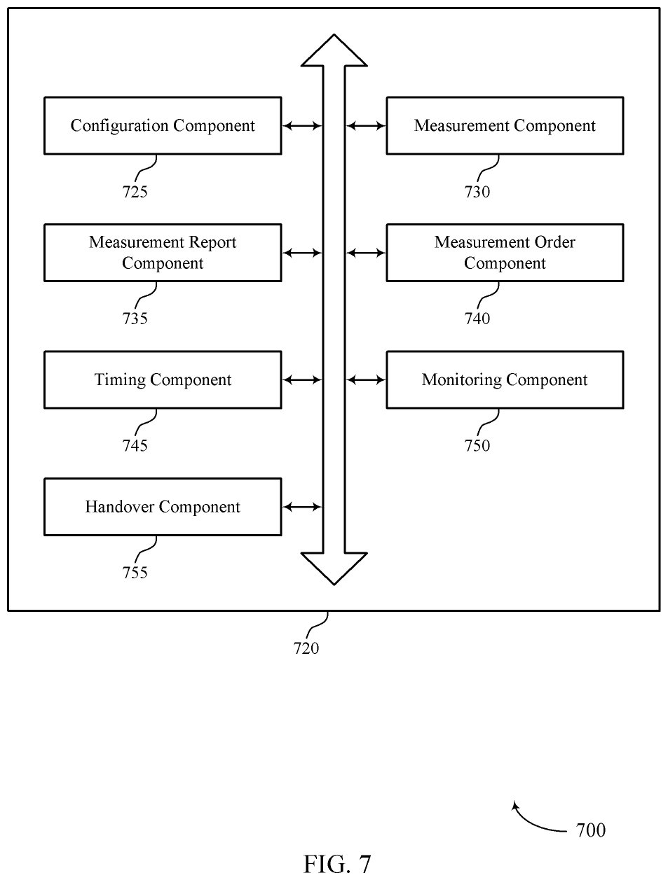

FIG. 7 shows a block diagram 700 of a communications manager 720 that supports inter-frequency measurement techniques in accordance with one or more aspects of the present disclosure. The communications manager 720 may be an example of aspects of a communications manager 520, a communications manager 620, or both, as described herein. The communications manager 720, or various components thereof, may be an example of means for performing various aspects of inter-frequency measurement techniques as described herein. For example, the communications manager 720 may include a configuration component 725, a measurement component 730, a measurement report component 735, a measurement order component 740, a timing component 745, a monitoring component 750, a handover component 755, or any combination thereof. Each of these components may communicate, directly or indirectly, with one another (e.g., via one or more buses).

The communications manager 720 may support wireless communications at a UE in accordance with examples as disclosed herein. The configuration component 725 may be configured as or otherwise support a means for receiving a first control message indicating respective measurement configurations for a set of multiple measurement objects. The measurement component 730 may be configured as or otherwise support a means for performing a measurement of a first measurement object from the set of multiple measurement objects in accordance with a measurement order, where the measurement order is determined using a set of parameters corresponding to a current state of the UE, one or more services at the UE, a user preference, or any combination thereof. The measurement report component 735 may be configured as or otherwise support a means for transmitting a first measurement report for the first measurement object based at least part on one or more reporting conditions being satisfied, the first measurement report being transmitted in accordance with the measurement order.

In some examples, the measurement order component 740 may be configured as or otherwise support a means for generating a metric for each measurement object of the set of multiple measurement objects based on the set of parameters. In some examples, the measurement order component 740 may be configured as or otherwise support a means for sorting the set of multiple measurement objects according to the generated metrics, where the measurement order is determined based on the sorting.

In some examples, the set of parameters includes one or more of a throughput parameter, a latency parameter, a battery status parameter, a voice communications parameter, or a mobility parameter.

In some examples, at least one parameter of the set of parameters is weighted according to the user preference.

In some examples, the measurement order component 740 may be configured as or otherwise support a means for transmitting a message including an indication of the determined measurement order.

In some examples, the timing component 745 may be configured as or otherwise support a means for initiating a first timer based on transmitting the first measurement report. In some examples, the monitoring component 750 may be configured as or otherwise support a means for monitoring for a second control message indicating a configuration associated with the first measurement report.

In some examples, the configuration component 725 may be configured as or otherwise support a means for receiving the second control message indicating the configuration associated with the first measurement report. In some examples, the timing component 745 may be configured as or otherwise support a means for stopping the first timer based on receiving the second control message. In some examples, the handover component 755 may be configured as or otherwise support a means for performing a handover procedure based on the second control message indicating the configuration associated with the first measurement report.

In some examples, the monitoring component 750 may be configured as or otherwise support a means for determining an absence of the second control message upon an expiration of the first timer. In some examples, the measurement component 730 may be configured as or otherwise support a means for performing a second measurement of a second measurement object from the set of multiple measurement objects in accordance with the measurement order, the second measurement being performed based on the absence of the second control message. In some examples, the measurement report component 735 may be configured as or otherwise support a means for transmitting a second measurement report for the second measurement object from the set of multiple measurement objects based at least part on the one or more reporting conditions, the second measurement report being transmitted in accordance with the measurement order.

In some examples, the timing component 745 may be configured as or otherwise support a means for initiating a second timer based on transmitting the second measurement report. In some examples, the monitoring component 750 may be configured as or otherwise support a means for monitoring for a third control message indicating a configuration associated with the second measurement report.

In some examples, the configuration component 725 may be configured as or otherwise support a means for receiving the third control message indicating the configuration associated with the second measurement object. In some examples, the timing component 745 may be configured as or otherwise support a means for stopping the second timer based on receiving the third control message. In some examples, the handover component 755 may be configured as or otherwise support a means for performing a handover procedure based on the third control message indicating the configuration associated with the second measurement report.

In some examples, the monitoring component 750 may be configured as or otherwise support a means for determining an absence of the third control message upon an expiration of the second timer. In some examples, the measurement component 730 may be configured as or otherwise support a means for performing a third measurement of a third measurement object of the set of multiple measurement objects in accordance with the measurement order, the third measurement being performed based on the absence of the third control message. In some examples, the measurement report component 735 may be configured as or otherwise support a means for transmitting a third measurement report for the third measurement object from the set of multiple measurement objects based at least part on the one or more reporting conditions, the third measurement report being transmitted in accordance with the measurement order.

In some examples, the measurement order component 740 may be configured as or otherwise support a means for selecting the first measurement object for performing the measurement based on the set of parameters indicating a priority for high data rates, low latency, low mobility, or any combination thereof, where the measurement order is determined based on the priority.

In some examples, the measurement order component 740 may be configured as or otherwise support a means for selecting the first measurement object based on the set of parameters indicating a priority for a low battery mode, voice over new radio communications, high mobility, or any combination thereof, where the measurement order is determined based on the priority.

In some examples, the measurement order component 740 may be configured as or otherwise support a means for selecting the first measurement object based on the set of parameters indicating a priority for voice over new radio communications, low mobility, or both, where the measurement order is determined based on the priority.

In some examples, each measurement object of the set of multiple measurement objects is associated with a mmW frequency band, a TDD frequency band, or a FDD frequency band.

Additionally, or alternatively, the communications manager 720 may support wireless communications at a UE in accordance with examples as disclosed herein. In some examples, the configuration component 725 may be configured as or otherwise support a means for receiving a first control message indicating respective measurement configurations for a set of multiple measurement objects. In some examples, the measurement component 730 may be configured as or otherwise support a means for performing measurements of each of the set of multiple measurement objects. In some examples, the measurement report component 735 may be configured as or otherwise support a means for transmitting a first measurement report for a first measurement object based at least part on one or more reporting conditions being satisfied, the first measurement report being transmitted in accordance with a measurement order that is determined using a set of parameters corresponding to a current state of the UE, one or more services at the UE, a user preference, or any combination thereof.

In some examples, the timing component 745 may be configured as or otherwise support a means for initiating a first timer based on transmitting the first measurement report. In some examples, the monitoring component 750 may be configured as or otherwise support a means for monitoring for a second control message indicating a configuration associated with the first measurement report.

In some examples, the configuration component 725 may be configured as or otherwise support a means for receiving the second control message indicating the configuration associated with the first measurement report. In some examples, the timing component 745 may be configured as or otherwise support a means for stopping the first timer based on receiving the second control message. In some examples, the handover component 755 may be configured as or otherwise support a means for performing a handover procedure based on the second control message indicating the configuration associated with the first measurement report.

In some examples, the monitoring component 750 may be configured as or otherwise support a means for determining an absence of the second control message upon an expiration of the first timer. In some examples, the measurement report component 735 may be configured as or otherwise support a means for transmitting a second measurement report for a second measurement object from the set of multiple measurement objects based at least part on the one or more reporting conditions, the second measurement report being transmitted in accordance with the measurement order. In some examples, the timing component 745 may be configured as or otherwise support a means for initiating a second timer based on transmitting the second measurement report. In some examples, the monitoring component 750 may be configured as or otherwise support a means for monitoring for a third control message indicating a configuration associated with the second measurement report.

In some examples, the configuration component 725 may be configured as or otherwise support a means for receiving the third control message indicating the configuration associated with the second measurement object. In some examples, the timing component 745 may be configured as or otherwise support a means for stopping the second timer based on receiving the third control message. In some examples, the handover component 755 may be configured as or otherwise support a means for performing a handover procedure based on the third control message indicating the configuration associated with the second measurement report.

In some examples, the monitoring component 750 may be configured as or otherwise support a means for determining an absence of the third control message upon an expiration of the second timer. In some examples, the measurement report component 735 may be configured as or otherwise support a means for transmitting a third measurement report for a third measurement object from the set of multiple measurement objects based at least part on the one or more reporting conditions, the third measurement report being transmitted in accordance with the measurement order.

In some examples, the respective measurement configurations indicate the set of parameters corresponding to the current state of the UE, the one or more services at the UE, the user preference, or any combination thereof.

In some examples, the set of parameters includes one or more of a throughput parameter, a latency parameter, a battery status parameter, a voice communications parameter, or a mobility parameter.

In some examples, the respective measurement configurations indicate that at least one parameter of the set of parameters is weighted according to the user preference.

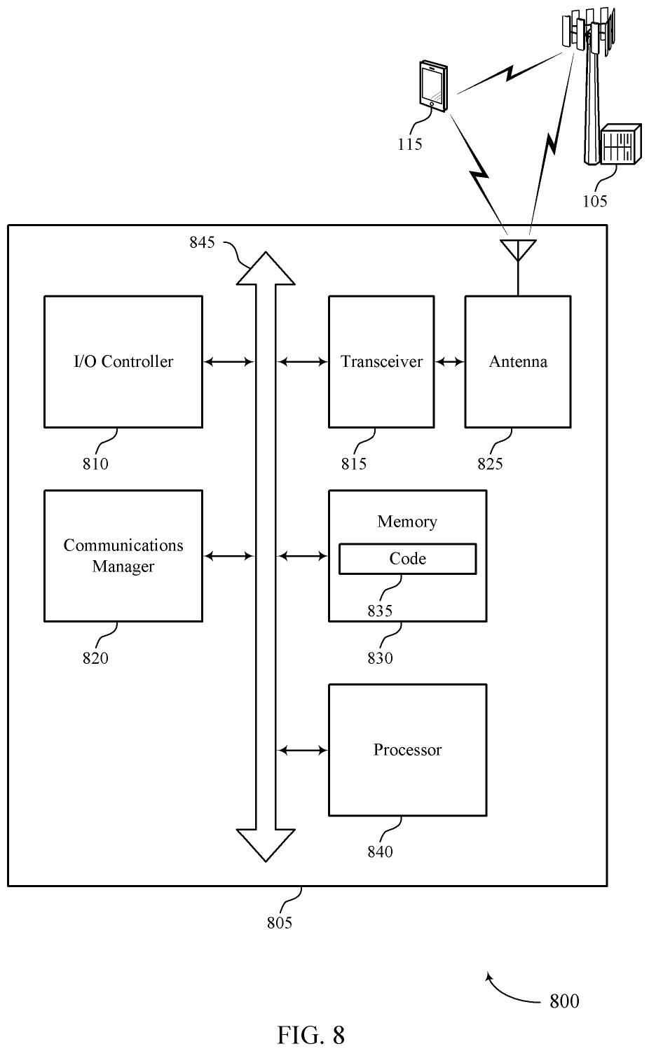

FIG. 8 shows a diagram of a system 800 including a device 805 that supports inter-frequency measurement techniques in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting inter-frequency measurement techniques). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for receiving a first control message indicating respective measurement configurations for a set of multiple measurement objects. The communications manager 820 may be configured as or otherwise support a means for performing a measurement of a first measurement object from the set of multiple measurement objects in accordance with a measurement order, where the measurement order is determined using a set of parameters corresponding to a current state of the UE, one or more services at the UE, a user preference, or any combination thereof. The communications manager 820 may be configured as or otherwise support a means for transmitting a first measurement report for the first measurement object based at least part on one or more reporting conditions being satisfied, the first measurement report being transmitted in accordance with the measurement order.

Additionally, or alternatively, the communications manager 820 may support wireless communications at a UE in accordance with examples as disclosed herein. For example, the communications manager 820 may be configured as or otherwise support a means for receiving a first control message indicating respective measurement configurations for a set of multiple measurement objects. The communications manager 820 may be configured as or otherwise support a means for performing measurements of each of the set of multiple measurement objects. The communications manager 820 may be configured as or otherwise support a means for transmitting a first measurement report for a first measurement object based at least part on one or more reporting conditions being satisfied, the first measurement report being transmitted in accordance with a measurement order that is determined using a set of parameters corresponding to a current state of the UE, one or more services at the UE, a user preference, or any combination thereof.

By including or configuring the communications manager 820 in accordance with examples as described herein, the device 805 may support inter-frequency measurement techniques for determining a measurement order based on a current UE state, services, and/or user preferences which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of inter-frequency measurement techniques as described herein, or the processor 840 and the memory 830 may be otherwise configured to perform or support such operations.

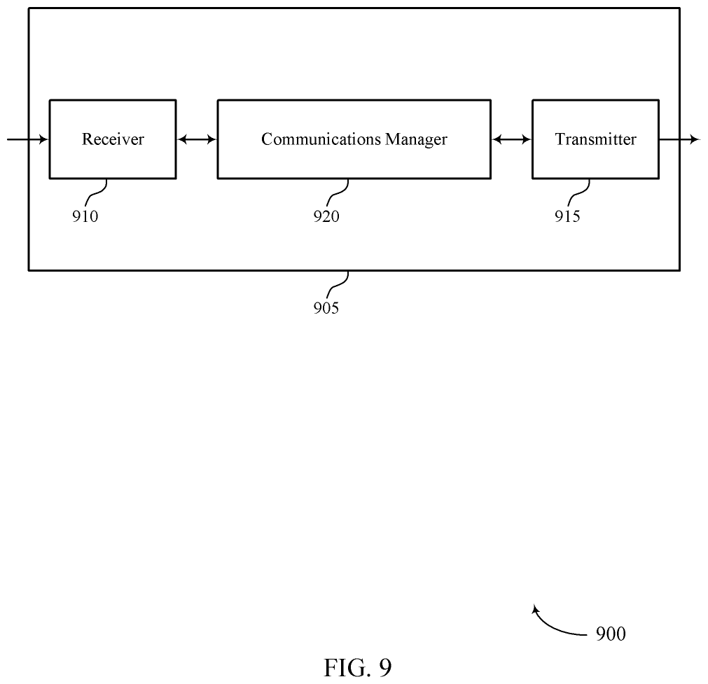

FIG. 9 shows a block diagram 900 of a device 905 that supports inter-frequency measurement techniques in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of inter-frequency measurement techniques as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 may be configured as or otherwise support a means for transmitting a control message indicating respective measurement configurations for a set of multiple measurement objects. The communications manager 920 may be configured as or otherwise support a means for receiving a message including an indication of a measurement order that is based on a set of parameters corresponding to a current state of a UE, one or more services at the UE, a user preference, or any combination thereof. The communications manager 920 may be configured as or otherwise support a means for receiving a first measurement report for a first measurement object from the set of multiple measurement objects based at least part on one or more reporting conditions being satisfied, the first measurement report being received in accordance with the measurement order. The communications manager 920 may be configured as or otherwise support a means for comparing one or more quality metrics associated with the first measurement object to respective thresholds for performing a handover of the UE, where the first measurement report includes an indication of the one or more quality metrics.

By including or configuring the communications manager 920 in accordance with examples as described herein, the device 905 (e.g., a processor controlling or otherwise coupled with the receiver 910, the transmitter 915, the communications manager 920, or a combination thereof) may support inter-frequency measurement techniques for determining a measurement order based on a current UE state, services, and/or user preferences which may result in reduced processing, reduced power consumption, and more efficient utilization of communication resources, among other advantages.

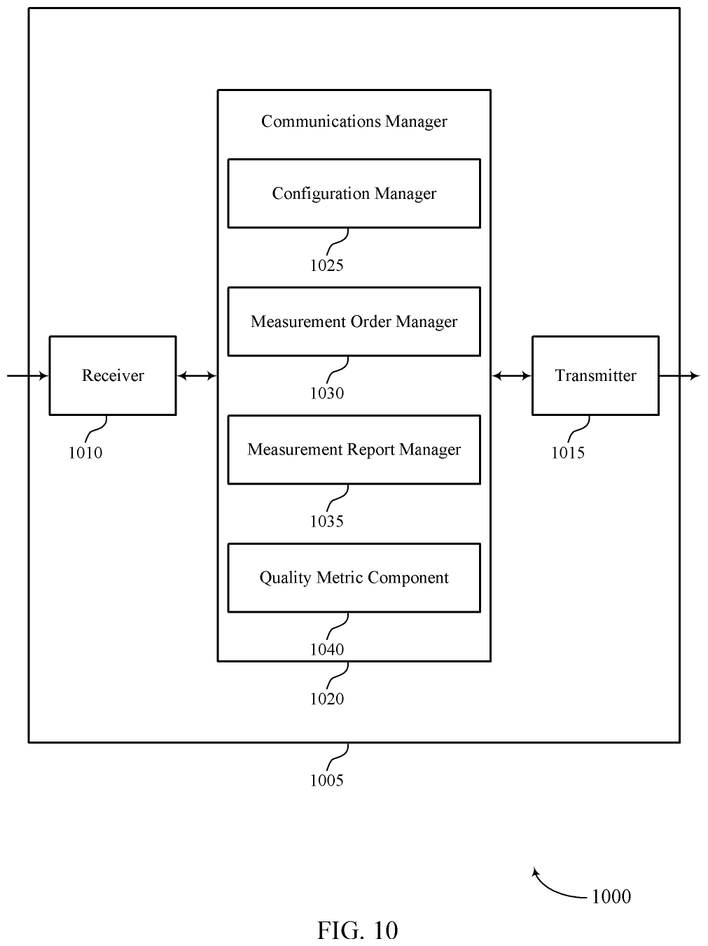

FIG. 10 shows a block diagram 1000 of a device 1005 that supports inter-frequency measurement techniques in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of inter-frequency measurement techniques as described herein. For example, the communications manager 1020 may include a configuration manager 1025, a measurement order manager 1030, a measurement report manager 1035, a quality metric component 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The configuration manager 1025 may be configured as or otherwise support a means for transmitting a control message indicating respective measurement configurations for a set of multiple measurement objects. The measurement order manager 1030 may be configured as or otherwise support a means for receiving a message including an indication of a measurement order that is based on a set of parameters corresponding to a current state of a UE, one or more services at the UE, a user preference, or any combination thereof. The measurement report manager 1035 may be configured as or otherwise support a means for receiving a first measurement report for a first measurement object from the set of multiple measurement objects based at least part on one or more reporting conditions being satisfied, the first measurement report being received in accordance with the measurement order. The quality metric component 1040 may be configured as or otherwise support a means for comparing one or more quality metrics associated with the first measurement object to respective thresholds for performing a handover of the UE, where the first measurement report includes an indication of the one or more quality metrics.

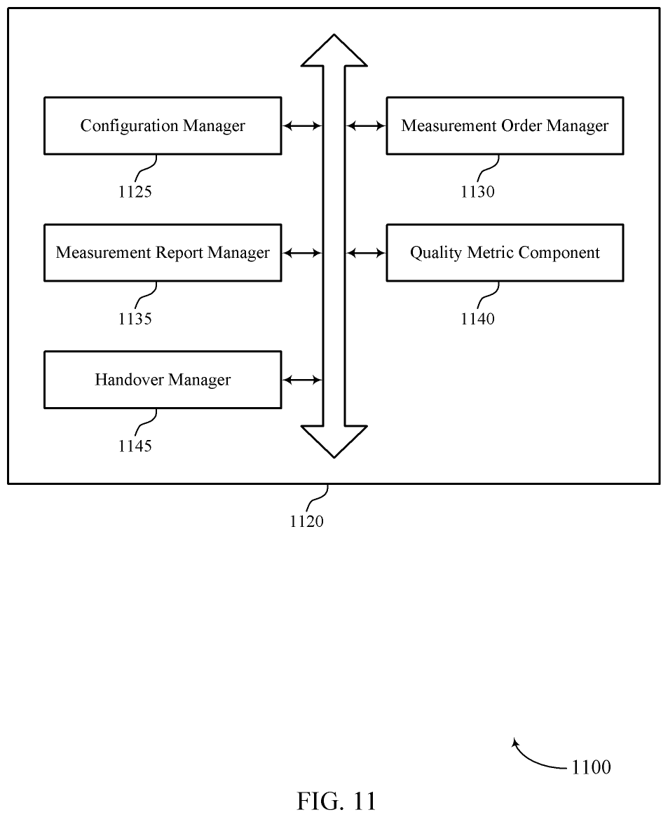

FIG. 11 shows a block diagram 1100 of a communications manager 1120 that supports inter-frequency measurement techniques in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of inter-frequency measurement techniques as described herein. For example, the communications manager 1120 may include a configuration manager 1125, a measurement order manager 1130, a measurement report manager 1135, a quality metric component 1140, a handover manager 1145, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The configuration manager 1125 may be configured as or otherwise support a means for transmitting a control message indicating respective measurement configurations for a set of multiple measurement objects. The measurement order manager 1130 may be configured as or otherwise support a means for receiving a message including an indication of a measurement order that is based on a set of parameters corresponding to a current state of a UE, one or more services at the UE, a user preference, or any combination thereof. The measurement report manager 1135 may be configured as or otherwise support a means for receiving a first measurement report for a first measurement object from the set of multiple measurement objects based at least part on one or more reporting conditions being satisfied, the first measurement report being received in accordance with the measurement order. The quality metric component 1140 may be configured as or otherwise support a means for comparing one or more quality metrics associated with the first measurement object to respective thresholds for performing a handover of the UE, where the first measurement report includes an indication of the one or more quality metrics.

In some examples, the quality metric component 1140 may be configured as or otherwise support a means for determining that the one or more quality metrics associated with the first measurement object satisfy the respective thresholds for performing a handover of the UE. In some examples, the configuration manager 1125 may be configured as or otherwise support a means for transmitting a second control message indicating a configuration associated with the first measurement object. In some examples, the handover manager 1145 may be configured as or otherwise support a means for performing a handover procedure based on the second control message indicating the configuration associated with the first measurement object.

In some examples, the measurement report manager 1135 may be configured as or otherwise support a means for receiving a second measurement report for a second measurement object from the set of multiple measurement objects based at least part on the one or more reporting conditions being satisfied, the second measurement report being transmitted in accordance with the measurement order. In some examples, the quality metric component 1140 may be configured as or otherwise support a means for comparing one or more quality metrics associated with the second measurement object to the respective thresholds for performing a handover of the UE, where the second measurement report includes an indication of the one or more quality metrics.

In some examples, the quality metric component 1140 may be configured as or otherwise support a means for determining that the one or more quality metrics associated with the second measurement object satisfy the respective thresholds for performing a handover of the UE. In some examples, the configuration manager 1125 may be configured as or otherwise support a means for transmitting a third control message indicating a configuration associated with the second measurement object. In some examples, the handover manager 1145 may be configured as or otherwise support a means for performing a handover procedure based on the third control message indicating the configuration associated with the second measurement object.

In some examples, the measurement report manager 1135 may be configured as or otherwise support a means for receiving a third measurement report for a third measurement object from the set of multiple measurement objects based at least part on the one or more reporting conditions being satisfied, the third measurement report being transmitted in accordance with the measurement order.

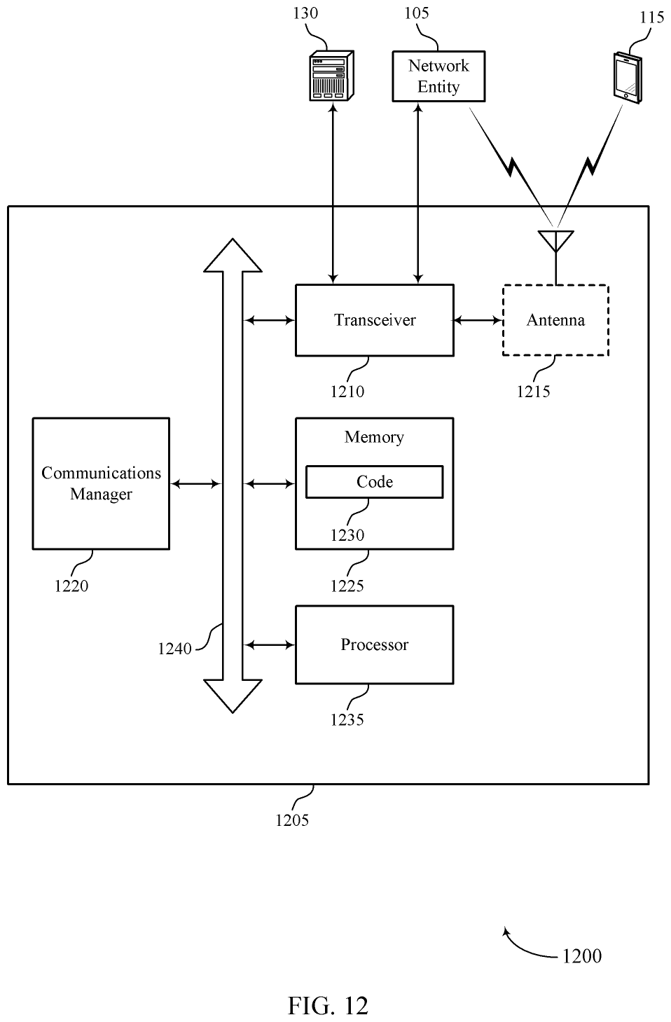

FIG. 12 shows a diagram of a system 1200 including a device 1205 that supports inter-frequency measurement techniques in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting inter-frequency measurement techniques). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 may be configured as or otherwise support a means for transmitting a control message indicating respective measurement configurations for a set of multiple measurement objects. The communications manager 1220 may be configured as or otherwise support a means for receiving a message including an indication of a measurement order that is based on a set of parameters corresponding to a current state of a UE, one or more services at the UE, a user preference, or any combination thereof. The communications manager 1220 may be configured as or otherwise support a means for receiving a first measurement report for a first measurement object from the set of multiple measurement objects based at least part on one or more reporting conditions being satisfied, the first measurement report being received in accordance with the measurement order. The communications manager 1220 may be configured as or otherwise support a means for comparing one or more quality metrics associated with the first measurement object to respective thresholds for performing a handover of the UE, where the first measurement report includes an indication of the one or more quality metrics.

By including or configuring the communications manager 1220 in accordance with examples as described herein, the device 1205 may support inter-frequency measurement techniques for determining a measurement order based on a current UE state, services, and/or user preferences which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of inter-frequency measurement techniques as described herein, or the processor 1235 and the memory 1225 may be otherwise configured to perform or support such operations.

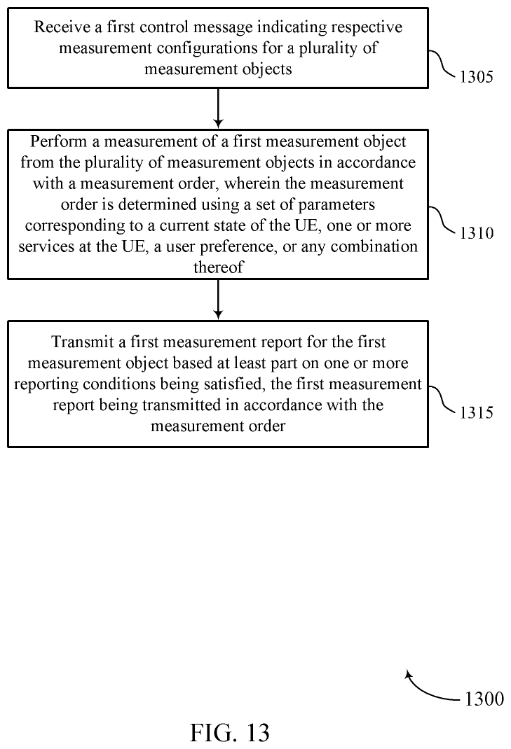

FIG. 13 shows a flowchart illustrating a method 1300 that supports inter-frequency measurement techniques in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a first control message indicating respective measurement configurations for a set of multiple measurement objects. The operations of 1305 may be performed in accordance with examples as disclosed herein. In some examples, aspects of the operations of 1305 may be performed by a configuration component 725 as described with reference to FIG. 7.

At 1310, the method may include performing a measurement of a first measurement object from the set of multiple measurement objects in accordance with a measurement order, where the measurement order is determined using a set of parameters corresponding to a current state of the UE, one or more services at the UE, a user preference, or any combination thereof. The operations of 1310 may be performed in accordance with examples as disclosed herein. In some examples, aspects of the operations of 1310 may be performed by a measurement component 730 as described with reference to FIG. 7.

At 1315, the method may include transmitting a first measurement report for the first measurement object based at least part on one or more reporting conditions being satisfied, the first measurement report being transmitted in accordance with the measurement order. The operations of 1315 may be performed in accordance with examples as disclosed herein. In some examples, aspects of the operations of 1315 may be performed by a measurement report component 735 as described with reference to FIG. 7.

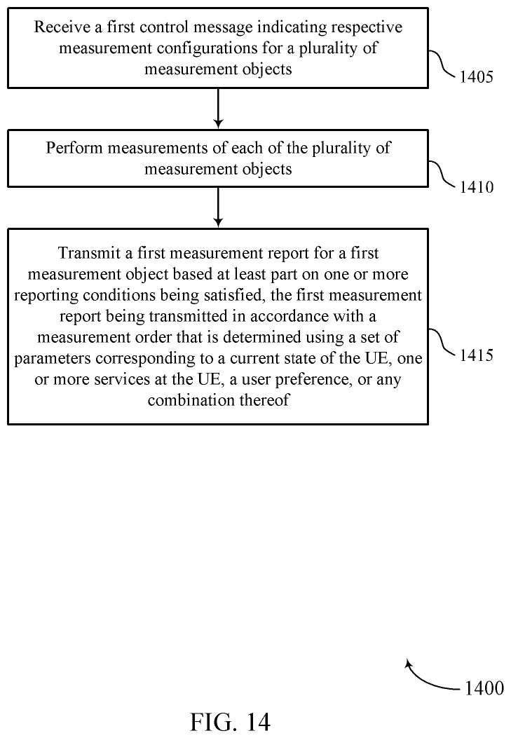

FIG. 14 shows a flowchart illustrating a method 1400 that supports inter-frequency measurement techniques in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a first control message indicating respective measurement configurations for a set of multiple measurement objects. The operations of 1405 may be performed in accordance with examples as disclosed herein. In some examples, aspects of the operations of 1405 may be performed by a configuration component 725 as described with reference to FIG. 7.

At 1410, the method may include performing measurements of each of the set of multiple measurement objects. The operations of 1410 may be performed in accordance with examples as disclosed herein. In some examples, aspects of the operations of 1410 may be performed by a measurement component 730 as described with reference to FIG. 7.

At 1415, the method may include transmitting a first measurement report for a first measurement object based at least part on one or more reporting conditions being satisfied, the first measurement report being transmitted in accordance with a measurement order that is determined using a set of parameters corresponding to a current state of the UE, one or more services at the UE, a user preference, or any combination thereof. The operations of 1415 may be performed in accordance with examples as disclosed herein. In some examples, aspects of the operations of 1415 may be performed by a measurement report component 735 as described with reference to FIG. 7.

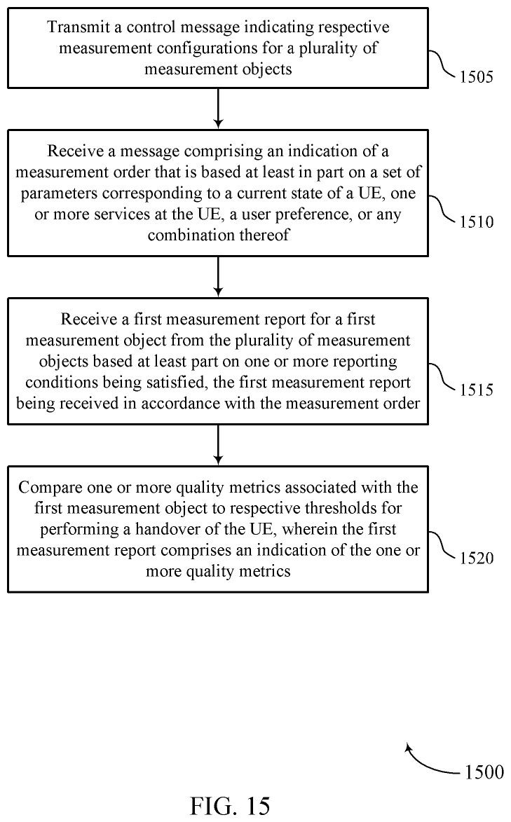

FIG. 15 shows a flowchart illustrating a method 1500 that supports inter-frequency measurement techniques in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting a control message indicating respective measurement configurations for a set of multiple measurement objects. The operations of 1505 may be performed in accordance with examples as disclosed herein. In some examples, aspects of the operations of 1505 may be performed by a configuration manager 1125 as described with reference to FIG. 11.

At 1510, the method may include receiving a message including an indication of a measurement order that is based on a set of parameters corresponding to a current state of a UE, one or more services at the UE, a user preference, or any combination thereof. The operations of 1510 may be performed in accordance with examples as disclosed herein. In some examples, aspects of the operations of 1510 may be performed by a measurement order manager 1130 as described with reference to FIG. 11.

At 1515, the method may include receiving a first measurement report for a first measurement object from the set of multiple measurement objects based at least part on one or more reporting conditions being satisfied, the first measurement report being received in accordance with the measurement order. The operations of 1515 may be performed in accordance with examples as disclosed herein. In some examples, aspects of the operations of 1515 may be performed by a measurement report manager 1135 as described with reference to FIG. 11.

At 1520, the method may include comparing one or more quality metrics associated with the first measurement object to respective thresholds for performing a handover of the UE, where the first measurement report includes an indication of the one or more quality metrics. The operations of 1520 may be performed in accordance with examples as disclosed herein. In some examples, aspects of the operations of 1520 may be performed by a quality metric component 1140 as described with reference to FIG. 11.

The following provides an overview of aspects of the present disclosure:

Aspect 1: A method for wireless communications at a UE, comprising: receiving a first control message indicating respective measurement configurations for a plurality of measurement objects; performing a measurement of a first measurement object from the plurality of measurement objects in accordance with a measurement order, wherein the measurement order is determined using a set of parameters corresponding to a current state of the UE, one or more services at the UE, a user preference, or any combination thereof; and transmitting a first measurement report for the first measurement object based at least part on one or more reporting conditions being satisfied, the first measurement report being transmitted in accordance with the measurement order.

Aspect 2: The method of aspect 1, further comprising: generating a metric for each measurement object of the plurality of measurement objects based at least in part on the set of parameters; and sorting the plurality of measurement objects according to the generated metrics, wherein the measurement order is determined based at least in part on the sorting.

Aspect 3: The method of aspect 2, wherein the set of parameters includes one or more of a throughput parameter, a latency parameter, a battery status parameter, a voice communications parameter, or a mobility parameter.

Aspect 4: The method of any of aspects 2 through 3, wherein at least one parameter of the set of parameters is weighted according to the user preference.

Aspect 5: The method of any of aspects 1 through 4, further comprising: transmitting a message comprising an indication of the determined measurement order.

Aspect 6: The method of any of aspects 1 through 5, further comprising: initiating a first timer based at least in part on transmitting the first measurement report; and monitoring for a second control message indicating a configuration associated with the first measurement report.

Aspect 7: The method of aspect 6, further comprising: receiving the second control message indicating the configuration associated with the first measurement report; stopping the first timer based at least in part on receiving the second control message; and performing a handover procedure based at least in part on the second control message indicating the configuration associated with the first measurement report.

Aspect 8: The method of any of aspects 6 through 7, further comprising: determining an absence of the second control message upon an expiration of the first timer; performing a second measurement of a second measurement object from the plurality of measurement objects in accordance with the measurement order, the second measurement being performed based at least in part on the absence of the second control message; and transmitting a second measurement report for the second measurement object from the plurality of measurement objects based at least part on the one or more reporting conditions, the second measurement report being transmitted in accordance with the measurement order.

Aspect 9: The method of aspect 8, further comprising: initiating a second timer based at least in part on transmitting the second measurement report; and monitoring for a third control message indicating a configuration associated with the second measurement report.

Aspect 10: The method of aspect 9, further comprising: receiving the third control message indicating the configuration associated with the second measurement object; stopping the second timer based at least in part on receiving the third control message; and performing a handover procedure based at least in part on the third control message indicating the configuration associated with the second measurement report.

Aspect 11: The method of any of aspects 9 through 10, further comprising: determining an absence of the third control message upon an expiration of the second timer; performing a third measurement of a third measurement object of the plurality of measurement objects in accordance with the measurement order, the third measurement being performed based at least in part on the absence of the third control message; and transmitting a third measurement report for the third measurement object from the plurality of measurement objects based at least part on the one or more reporting conditions, the third measurement report being transmitted in accordance with the measurement order.

Aspect 12: The method of any of aspects 1 through 11, further comprising: selecting the first measurement object for performing the measurement based at least in part on the set of parameters indicating a priority for high data rates, low latency, low mobility, or any combination thereof, wherein the measurement order is determined based at least in part on the priority.

Aspect 13: The method of any of aspects 1 through 12, further comprising: selecting the first measurement object based at least in part on the set of parameters indicating a priority for a low battery mode, voice over new radio communications, high mobility, or any combination thereof, wherein the measurement order is determined based at least in part on the priority.

Aspect 14: The method of any of aspects 1 through 13, further comprising: selecting the first measurement object based at least in part on the set of parameters indicating a priority for voice over new radio communications, low mobility, or both, wherein the measurement order is determined based at least in part on the priority.

Aspect 15: The method of any of aspects 1 through 14, wherein each measurement object of the plurality of measurement objects is associated with a millimeter wave frequency band, a time division duplex frequency band, or a frequency division duplex frequency band.

Aspect 16: A method for wireless communications at a UE, comprising: receiving a first control message indicating respective measurement configurations for a plurality of measurement objects; performing measurements of each of the plurality of measurement objects; and transmitting a first measurement report for a first measurement object based at least part on one or more reporting conditions being satisfied, the first measurement report being transmitted in accordance with a measurement order that is determined using a set of parameters corresponding to a current state of the UE, one or more services at the UE, a user preference, or any combination thereof.

Aspect 17: The method of aspect 16, further comprising: initiating a first timer based at least in part on transmitting the first measurement report; and monitoring for a second control message indicating a configuration associated with the first measurement report.

Aspect 18: The method of aspect 17, further comprising: receiving the second control message indicating the configuration associated with the first measurement report; stopping the first timer based at least in part on receiving the second control message; and performing a handover procedure based at least in part on the second control message indicating the configuration associated with the first measurement report.

Aspect 19: The method of any of aspects 17 through 18, further comprising: determining an absence of the second control message upon an expiration of the first timer; transmitting a second measurement report for a second measurement object from the plurality of measurement objects based at least part on the one or more reporting conditions, the second measurement report being transmitted in accordance with the measurement order; initiating a second timer based at least in part on transmitting the second measurement report; and monitoring for a third control message indicating a configuration associated with the second measurement report.

Aspect 20: The method of aspect 19, further comprising: receiving the third control message indicating the configuration associated with the second measurement object; stopping the second timer based at least in part on receiving the third control message; and performing a handover procedure based at least in part on the third control message indicating the configuration associated with the second measurement report.

Aspect 21: The method of any of aspects 19 through 20, further comprising: determining an absence of the third control message upon an expiration of the second timer; and transmitting a third measurement report for a third measurement object from the plurality of measurement objects based at least part on the one or more reporting conditions, the third measurement report being transmitted in accordance with the measurement order.

Aspect 22: The method of any of aspects 17 through 21, wherein the respective measurement configurations indicate the set of parameters corresponding to the current state of the UE, the one or more services at the UE, the user preference, or any combination thereof.

Aspect 23: The method of aspect 22, wherein the set of parameters includes one or more of a throughput parameter, a latency parameter, a battery status parameter, a voice communications parameter, or a mobility parameter.

Aspect 24: The method of any of aspects 22 through 23, wherein the respective measurement configurations indicate that at least one parameter of the set of parameters is weighted according to the user preference.

Aspect 25: A method for wireless communications at a network entity, comprising: transmitting a control message indicating respective measurement configurations for a plurality of measurement objects; receiving a message comprising an indication of a measurement order that is based at least in part on a set of parameters corresponding to a current state of a UE, one or more services at the UE, a user preference, or any combination thereof; receiving a first measurement report for a first measurement object from the plurality of measurement objects based at least part on one or more reporting conditions being satisfied, the first measurement report being received in accordance with the measurement order; and comparing one or more quality metrics associated with the first measurement object to respective thresholds for performing a handover of the UE, wherein the first measurement report comprises an indication of the one or more quality metrics.

Aspect 26: The method of aspect 25, further comprising: determining that the one or more quality metrics associated with the first measurement object satisfy the respective thresholds for performing a handover of the UE; transmitting a second control message indicating a configuration associated with the first measurement object; and performing a handover procedure based at least in part on the second control message indicating the configuration associated with the first measurement object.

Aspect 27: The method of any of aspects 25 through 26, further comprising: receiving a second measurement report for a second measurement object from the plurality of measurement objects based at least part on the one or more reporting conditions being satisfied, the second measurement report being transmitted in accordance with the measurement order; and comparing one or more quality metrics associated with the second measurement object to the respective thresholds for performing a handover of the UE, wherein the second measurement report comprises an indication of the one or more quality metrics.

Aspect 28: The method of aspect 27, further comprising: determining that the one or more quality metrics associated with the second measurement object satisfy the respective thresholds for performing a handover of the UE; transmitting a third control message indicating a configuration associated with the second measurement object; and performing a handover procedure based at least in part on the third control message indicating the configuration associated with the second measurement object.

Aspect 29: The method of any of aspects 27 through 28, further comprising: receiving a third measurement report for a third measurement object from the plurality of measurement objects based at least part on the one or more reporting conditions being satisfied, the third measurement report being transmitted in accordance with the measurement order.

Aspect 30: An apparatus for wireless communications at a UE, comprising a processor; memory coupled with the processor; and instructions stored in the memory and executable by the processor to cause the apparatus to perform a method of any of aspects 1 through 15.

Aspect 31: An apparatus for wireless communications at a UE, comprising at least one means for performing a method of any of aspects 1 through 15.

Aspect 32: A non-transitory computer-readable medium storing code for wireless communications at a UE, the code comprising instructions executable by a processor to perform a method of any of aspects 1 through 15.

Aspect 33: An apparatus for wireless communications at a UE, comprising a processor; memory coupled with the processor; and instructions stored in the memory and executable by the processor to cause the apparatus to perform a method of any of aspects 16 through 24.

Aspect 34: An apparatus for wireless communications at a UE, comprising at least one means for performing a method of any of aspects 16 through 24.

Aspect 35: A non-transitory computer-readable medium storing code for wireless communications at a UE, the code comprising instructions executable by a processor to perform a method of any of aspects 16 through 24.

Aspect 36: An apparatus for wireless communications at a network entity, comprising a processor; memory coupled with the processor; and instructions stored in the memory and executable by the processor to cause the apparatus to perform a method of any of aspects 25 through 29.

Aspect 37: An apparatus for wireless communications at a network entity, comprising at least one means for performing a method of any of aspects 25 through 29.

Aspect 38: A non-transitory computer-readable medium storing code for wireless communications at a network entity, the code comprising instructions executable by a processor to perform a method of any of aspects 25 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving a first control message indicating respective measurement configurations for a plurality of measurement objects;
performing a measurement of a first measurement object from the plurality of measurement objects in accordance with a measurement order, wherein the measurement order is determined using a set of parameters corresponding to a current state of the UE, one or more services at the UE, a user preference, or any combination thereof; and
transmitting a first measurement report for the first measurement object based at least part on one or more reporting conditions being satisfied, the first measurement report being transmitted in accordance with the measurement order.

2. The method of claim 1, further comprising:
generating a metric for each measurement object of the plurality of measurement objects based at least in part on the set of parameters; and
sorting the plurality of measurement objects according to the generated metrics, wherein the measurement order is determined based at least in part on the sorting.

3. The method of claim 2, wherein the set of parameters includes one or more of a throughput parameter, a latency parameter, a battery status parameter, a voice communications parameter, or a mobility parameter.

4. The method of claim 2, wherein at least one parameter of the set of parameters is weighted according to the user preference.

5. The method of claim 1, further comprising:
transmitting a message comprising an indication of the determined measurement order.

6. The method of claim 1, further comprising:
initiating a first timer based at least in part on transmitting the first measurement report; and
monitoring for a second control message indicating a configuration associated with the first measurement report.

7. The method of claim 6, further comprising:
receiving the second control message indicating the configuration associated with the first measurement report;
stopping the first timer based at least in part on receiving the second control message; and
performing a handover procedure based at least in part on the second control message indicating the configuration associated with the first measurement report.

8. The method of claim 6, further comprising:
determining an absence of the second control message upon an expiration of the first timer;
performing a second measurement of a second measurement object from the plurality of measurement objects in accordance with the measurement order, the second measurement being performed based at least in part on the absence of the second control message; and
transmitting a second measurement report for the second measurement object from the plurality of measurement objects based at least part on the one or more reporting conditions, the second measurement report being transmitted in accordance with the measurement order.

9. The method of claim 8, further comprising:
initiating a second timer based at least in part on transmitting the second measurement report; and
monitoring for a third control message indicating a configuration associated with the second measurement report.

10. The method of claim 9, further comprising:
receiving the third control message indicating the configuration associated with the second measurement object;
stopping the second timer based at least in part on receiving the third control message; and
performing a handover procedure based at least in part on the third control message indicating the configuration associated with the second measurement report.

11. The method of claim 9, further comprising:
determining an absence of the third control message upon an expiration of the second timer;
performing a third measurement of a third measurement object of the plurality of measurement objects in accordance with the measurement order, the third measurement being performed based at least in part on the absence of the third control message; and
transmitting a third measurement report for the third measurement object from the plurality of measurement objects based at least part on the one or more reporting conditions, the third measurement report being transmitted in accordance with the measurement order.

12. The method of claim 1, further comprising:
selecting the first measurement object for performing the measurement based at least in part on the set of parameters indicating a priority for high data rates, low latency, low mobility, or any combination thereof, wherein the measurement order is determined based at least in part on the priority.

13. The method of claim 1, further comprising:
selecting the first measurement object based at least in part on the set of parameters indicating a priority for a low battery mode, voice over new radio communications, high mobility, or any combination thereof, wherein the measurement order is determined based at least in part on the priority.

14. The method of claim 1, further comprising:
selecting the first measurement object based at least in part on the set of parameters indicating a priority for voice over new radio communications, low mobility, or both, wherein the measurement order is determined based at least in part on the priority.

15. The method of claim 1, wherein each measurement object of the plurality of measurement objects is associated with a millimeter wave frequency band, a time division duplex frequency band, or a frequency division duplex frequency band.

16. A method for wireless communications at a user equipment (UE), comprising:
receiving a first control message indicating respective measurement configurations for a plurality of measurement objects;
performing measurements of each of the plurality of measurement objects; and
transmitting a first measurement report for a first measurement object based at least part on one or more reporting conditions being satisfied, the first measurement report being transmitted in accordance with a measurement order that is determined using a set of parameters corresponding to a current state of the UE, one or more services at the UE, a user preference, or any combination thereof.

17. The method of claim 16, further comprising:
initiating a first timer based at least in part on transmitting the first measurement report; and
monitoring for a second control message indicating a configuration associated with the first measurement report.

18. The method of claim 17, further comprising:
receiving the second control message indicating the configuration associated with the first measurement report;
stopping the first timer based at least in part on receiving the second control message; and
performing a handover procedure based at least in part on the second control message indicating the configuration associated with the first measurement report.

19. The method of claim 17, further comprising:
determining an absence of the second control message upon an expiration of the first timer;
transmitting a second measurement report for a second measurement object from the plurality of measurement objects based at least part on the one or more reporting conditions, the second measurement report being transmitted in accordance with the measurement order;
initiating a second timer based at least in part on transmitting the second measurement report; and
monitoring for a third control message indicating a configuration associated with the second measurement report.

20. The method of claim 19, further comprising:
receiving the third control message indicating the configuration associated with the second measurement object;
stopping the second timer based at least in part on receiving the third control message; and
performing a handover procedure based at least in part on the third control message indicating the configuration associated with the second measurement report.

21. The method of claim 19, further comprising:
determining an absence of the third control message upon an expiration of the second timer; and
transmitting a third measurement report for a third measurement object from the plurality of measurement objects based at least part on the one or more reporting conditions, the third measurement report being transmitted in accordance with the measurement order.

22. The method of claim 17, wherein the respective measurement configurations indicate the set of parameters corresponding to the current state of the UE, the one or more services at the UE, the user preference, or any combination thereof.

23. The method of claim 22, wherein the set of parameters includes one or more of a throughput parameter, a latency parameter, a battery status parameter, a voice communications parameter, or a mobility parameter.

24. The method of claim 22, wherein the respective measurement configurations indicate that at least one parameter of the set of parameters is weighted according to the user preference.

25. A method for wireless communications at a network entity, comprising:
transmitting a control message indicating respective measurement configurations for a plurality of measurement objects;
receiving a message comprising an indication of a measurement order that is based at least in part on a set of parameters corresponding to a current state of a user equipment (UE), one or more services at the UE, a user preference, or any combination thereof;
receiving a first measurement report for a first measurement object from the plurality of measurement objects based at least part on one or more reporting conditions being satisfied, the first measurement report being received in accordance with the measurement order; and
comparing one or more quality metrics associated with the first measurement object to respective thresholds for performing a handover of the UE, wherein the first measurement report comprises an indication of the one or more quality metrics.

26. The method of claim 25, further comprising:
determining that the one or more quality metrics associated with the first measurement object satisfy the respective thresholds for performing a handover of the UE;
transmitting a second control message indicating a configuration associated with the first measurement object; and
performing a handover procedure based at least in part on the second control message indicating the configuration associated with the first measurement object.

27. The method of claim 25, further comprising:
receiving a second measurement report for a second measurement object from the plurality of measurement objects based at least part on the one or more reporting conditions being satisfied, the second measurement report being transmitted in accordance with the measurement order; and
comparing one or more quality metrics associated with the second measurement object to the respective thresholds for performing a handover of the UE, wherein the second measurement report comprises an indication of the one or more quality metrics.

28. The method of claim 27, further comprising:
determining that the one or more quality metrics associated with the second measurement object satisfy the respective thresholds for performing a handover of the UE;
transmitting a third control message indicating a configuration associated with the second measurement object; and
performing a handover procedure based at least in part on the third control message indicating the configuration associated with the second measurement object.

29. The method of claim 27, further comprising:
receiving a third measurement report for a third measurement object from the plurality of measurement objects based at least part on the one or more reporting conditions being satisfied, the third measurement report being transmitted in accordance with the measurement order.

30. An apparatus for wireless communications at a user equipment (UE), comprising:
a processor;
memory coupled with the processor; and
instructions stored in the memory and executable by the processor to cause the apparatus to:
receive a first control message indicating respective measurement configurations for a plurality of measurement objects;
perform a measurement of a first measurement object from the plurality of measurement objects in accordance with a measurement order, wherein the measurement order is determined using a set of parameters corresponding to a current state of the UE, one or more services at the UE, a user preference, or any combination thereof; and
transmit a first measurement report for the first measurement object based at least part on one or more reporting conditions being satisfied, the first measurement report being transmitted in accordance with the measurement order.
